(19) United States
(12) Patent Application Publication
(10) Pub. No.: US 2026/0322483 A1
(43) Pub. Date: Oct. 15, 2026

(54) ELECTRONIC DEVICE FOR PERFORMING SATELLITE COMMUNICATION AND OPERATION METHOD THEREOF

(71) Applicant: Samsung Electronics Co., Ltd., Suwon-si (KR)

(72) Inventors: Jaemoon CHA, Suwon-si (KR); Kyoungho Lee, Suwon-si (KR); Deunghyeon Jeong, Suwon-si (KR)

(73) Assignee: Samsung Electronics Co., Ltd., Suwon-si (KR)

(21) Appl. No.: 19/341,720

(22) Filed: Sep. 26, 2025

Related U.S. Application Data
(63) Continuation of application No. PCT/KR2024/003475, filed on Mar. 20, 2024.

(30) Foreign Application Priority Data
Mar. 28, 2023 (KR) 10-2023-0040218
May 2, 2023 (KR) 10-2023-0057256

(51) Int. Cl. H04B 7/185; H04W 8/18

(52) U.S. Cl. CPC H04B 7/18539; H04B 7/1855; H04B 7/18558; H04W 8/183

(57) ABSTRACT

An electronic device includes one or more processors including processing circuitry, and memory storing instructions. The instructions, when executed by the one or more processors individually or collectively, cause the electronic device to, based on a satellite being detected, identify whether connection information related to the satellite is present in the memory, based on the connection information related to the satellite being present in the memory, determine, based on the connection information, a transmission time point for transmitting a transmission signal to the satellite, and transmit, during the transmission time point, the transmission signal to the satellite.

### CROSS-REFERENCE TO RELATED APPLICATIONS

This application is a continuation application of International Application No. PCT/KR2024/003475, filed on Mar. 20, 2024, which claims priority to Korean Patent Application No. 10-2023-0040218, filed on Mar. 28, 2023, and to Korean Patent Application No. 10-2023-0057256, filed on May 2, 2023, in the Korean Intellectual Property Office, the disclosures of which are incorporated by reference herein in their entireties.

### BACKGROUND

### 1. Field

The present disclosure relates generally to wireless communication systems, and more particularly, to an electronic device for performing satellite communication and an operation method thereof.

### 2. Description of Related Art

A wireless communication system may provide wireless connectivity for electronic devices that may allow various electronic devices to perform wireless communication. The wireless communication system may allocate wireless frequency resources to electronic devices through the control of a base station that may be installed on the ground to provide wireless communication for the electronic devices. However, as base stations in wireless communication systems may typically be installed on the ground, electronic devices that may be located over the sea and/or at altitudes above a certain level may encounter difficulties in accessing the base stations of the wireless communication systems and/or performing wireless communications with other electronic devices.

In order to potentially address physical limitations of base stations that may be installed on the ground, wireless communication systems may evolve to incorporate satellite networks and/or terrestrial networks, thereby potentially extending the coverage for wireless connectivity of electronic devices to a global scale. That is, through the integration of terrestrial networks with satellite networks, wireless communication systems may provide wireless connectivity to electronic devices even in areas where terrestrial network deployment may be challenging and/or in disaster situations.

For example, such integrated wireless communication systems may include multiple satellites. Each satellite may orbit the Earth in a designated orbit. Since the orbits of satellites may not be all the same and/or may not be known, electronic devices may not necessarily be able to recognize (or estimate) the exact position of a satellite orbiting the Earth from the locations of the electronic devices based on, for example, the strength of a signal received from the satellite.

Consequently, an electronic device may transmit a signal (or satellite signal) to the satellite based on the maximum transmitting power of the electronic device to reliably transmit and/or receive signals to and/or from the satellite. Thereby, the electronic device may increase power consumption due performing signal transmission to the satellite based on the maximum transmission power.

In addition, since the electronic device may not recognize the exact location of the satellite, the electronic device may transmit a signal to the satellite based on a time point at which the electronic device receives the signal from the satellite. The time at which the satellite is able to receive a signal from the electronic device may be delayed from the time at which the electronic device is able to receive a signal from the satellite due to a difference in the transmission power of the electronic device and the transmission power of the satellite, such that the reach of the signal transmitted by the electronic device may be relatively shorter than the reach of the signal transmitted by the satellite. In such a case, the satellite may not receive the signal transmitted to the satellite based on the time point at which the electronic device receives the signal from the satellite. As a result, the electronic device may unnecessarily increase power consumption by transmitting unnecessary signals that the satellite may not receive.

### SUMMARY

One or more example embodiments of the present disclosure provide a device and method for configuring a time point at which the electronic device transmits a signal to the satellite.

The technical aspects addressed by the present disclosure may not be limited to the above technical aspects and other technical aspects may be apparent to those skilled in the art from the following description.

According to an aspect of the present disclosure, an electronic device includes one or more processors including processing circuitry, and memory storing instructions. The instructions, when executed by the one or more processors individually or collectively, cause the electronic device to, based on a satellite being detected, identify whether connection information related to the satellite is present in the memory, based on the connection information related to the satellite being present in the memory, determine, based on the connection information, a transmission time point for transmitting a transmission signal to the satellite, and transmit, during the transmission time point, the transmission signal to the satellite.

According to an aspect of the present disclosure, an operation method of an electronic device includes, based on a satellite being detected, identifying whether connection information related to the satellite is present in a memory of the electronic device, based on the connection information related to the satellite being present in the electronic device, determining a transmission time point for transmitting a transmission signal to the satellite, based on the connection information, and transmitting, during the transmission time point, the transmission signal to the satellite.

According to an aspect of the present disclosure, a non-transitory computer-readable storage medium storing computer-executable instructions for operating an electronic device that, when executed by at least one processor of the electronic device, cause the electronic device to, based on a satellite being detected, identify whether connection information related to the satellite is present in the memory, based on the connection information related to the satellite being present in the memory, determine, based on the connection information, a transmission time point for transmitting a transmission signal to the satellite, and transmit, during the transmission time point, the transmission signal to the satellite.

Further, one or more example embodiments of the present disclosure provide an electronic device that determines the time point for transmitting signals to the satellite based on the connection information with the satellite acquired by the electronic device at a previous time point, which may reduce the transmission of unnecessary signals, when compared to related electronic devices.

Further, one or more example embodiments of the present disclosure provide an electronic device that determines the transmission power of the signal and/or the transmission interval of the signal to be transmitted to the satellite based on the connection information with the satellite acquired at the previous time point in the electronic device, which may reduce the power consumption of satellite communications by the electronic device, when compared to related electronic devices.

The effects that may be acquired from various embodiments of the present disclosure may not be limited to the effects mentioned above, and other effects that are not mentioned may be apparent from the description below to those skilled in the art in which various embodiments of the present disclosure belong.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a block view illustrating an electronic device in a network environment, according to an embodiment;

FIG. 2A is a view illustrating an electronic device and a long-range communication network, according to an embodiment;

FIG. 2B is an example of a satellite network, according to an embodiment;

FIG. 3 is a block diagram illustrating an electronic device for performing satellite communications, according to an embodiment;

FIG. 4 is an example of connection information of a satellite acquired by an electronic device, according to an embodiment;

FIG. 5A is a flowchart for configuring a transmission time point of a signal in an electronic device, according to an embodiment;

FIG. 5B is a flowchart for selectively configuring a transmission time point of a signal in an electronic device based on connection information of a satellite, according to an embodiment;

FIG. 6 is an example of configuring a transmission time point of a signal in an electronic device, according to an embodiment;

FIG. 7 is an example of configuring a transmission time point of a signal in an electronic device, according to an embodiment;

FIG. 8 is flowchart for acquiring connection information of a satellite by an electronic device, according to an embodiment;

FIG. 9 is flowchart for configuring a connection restriction list of a satellite by an electronic device, according to an embodiment;

FIG. 10 is a flowchart for configuring transmission power of a signal to be transmitted from an electronic device to a satellite, according to an embodiment;

FIG. 11 is a flowchart for configuring transmission power of a signal to be transmitted from an electronic device to a satellite based on a quality of communication with a satellite, according to an embodiment;

FIG. 12 is a flowchart for configuring a transmission interval of a signal to be transmitted from an electronic device to a satellite, according to an embodiment;

FIG. 13 is an example of a transmission interval of a signal to be transmitted from an electronic device to a satellite, according to an embodiment;

FIG. 14 is a flowchart for selectively configuring a transmission time point of a signal in an electronic device, according to an embodiment;

FIG. 15A is an example of switching information to a power saving mode output from an electronic device, according to an embodiment;

FIG. 15B is an example of switching information to a power saving mode output from an electronic device, according to an embodiment;

FIG. 16 is flowchart for operation of a power saving mode related to satellite communication in an electronic device, according to an embodiment; and

FIG. 17 is an example of switching information to a power saving mode output from an electronic device, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

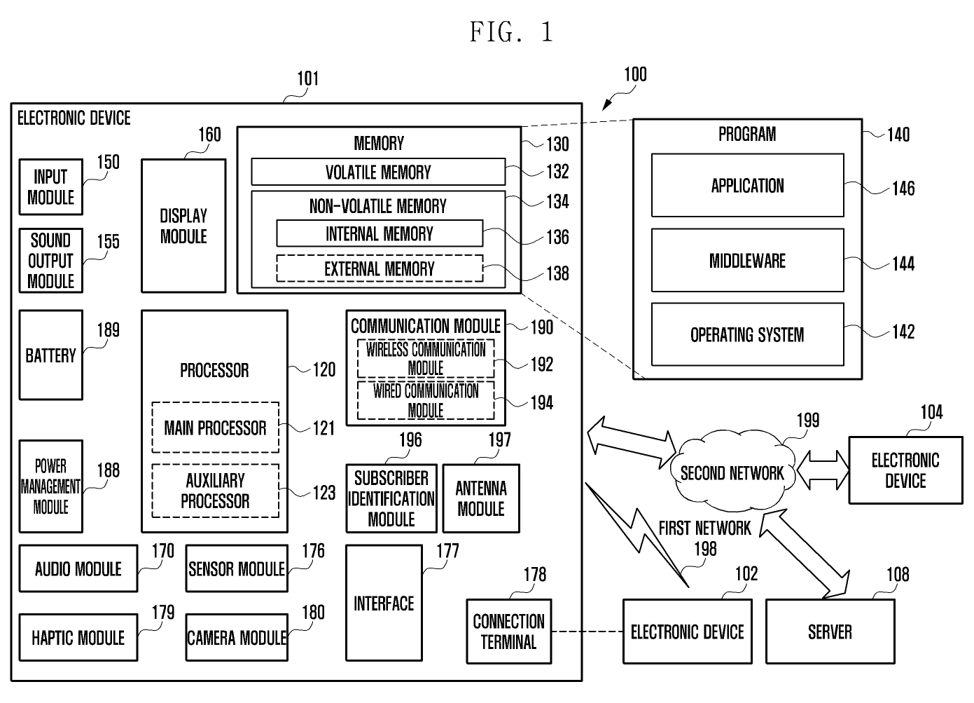

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 milliseconds (ms) or less for each of downlink (DL) and uplink (UL), or a round trip of 1 ms or less) for implementing URLLC. According to one embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include patch array antennas and/or dipole array antennas.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

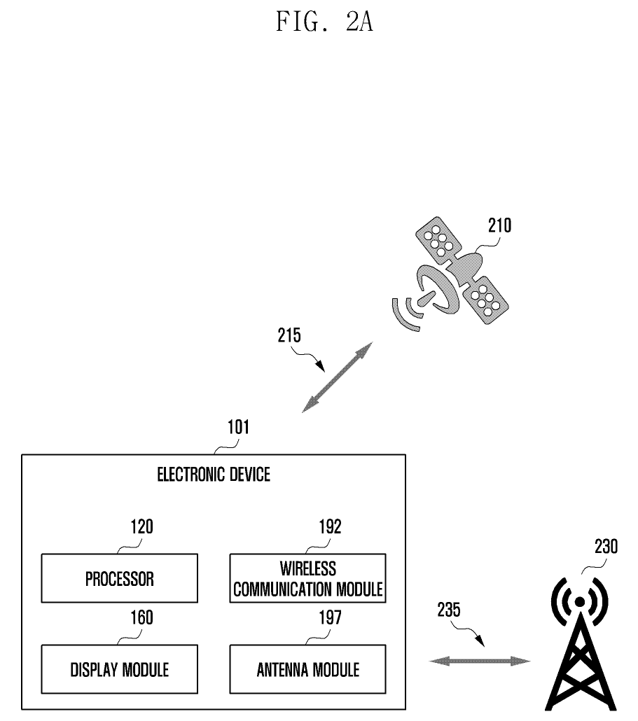

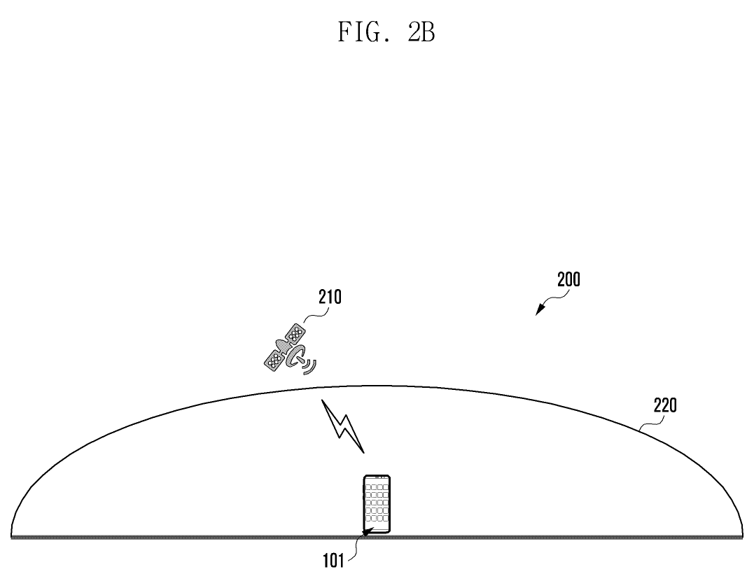

FIG. 2A is a view illustrating an electronic device and a long-range communication network, according to an embodiment.

Referring to FIG. 2A, an electronic device (e.g., the electronic device 101 in FIG. 1) may transmit and/or receive data through a terrestrial network 235 and/or non-terrestrial network 215.

The terrestrial network 235 may refer to a network capable of providing data communication through a terrestrial wireless communication device 230. For example, the terrestrial wireless communication device 230 may be and/or may include a base station located on the ground (e.g., fixed to the ground). The terrestrial wireless communication device 230 may support at least one communication method from among various communication methods supportable by the electronic device 101. For example, the terrestrial wireless communication device 230 may include, but not be limited to, an Evolved Universal Terrestrial Radio Access Network (E-UTRAN) Node B (eNodeB or eNB) or Next Generation Node B (gNodeB or gNB). However, embodiments of the present disclosure are not limited thereto.

The non-terrestrial network 215 may refer to a network capable of providing data communication through at least one non-terrestrial wireless communication device 210. For example, the non-terrestrial wireless communication device 210 may be and/or may include at least one of various communication devices, such as, but not limited to, a base station or a relay not located on the ground. For example, the non-terrestrial wireless communication device 210 may be and/or may include a satellite and/or unmanned aerial vehicle. However, embodiments of the present disclosure are not limited thereto. For example, the satellite may include, but not be limited to, a low-earth orbit (LEO) satellite, a medium-earth orbit (MEO) satellite, a geostationary earth orbit (GEO) satellite, and/or a high elliptical orbit (HEO) satellite. As another example, the satellite may include a mobile satellite and/or a geostationary satellite. However, embodiments of the present disclosure are not limited thereto.

The non-terrestrial wireless communication device 210 may support at least one of various wireless communication methods. For example, the non-terrestrial wireless communication device 210 may support a New Radio (NR) non-terrestrial network (NTN) as defined or promulgated by the Third Generation Partnership Project (3GPP). Alternatively or additionally, the non-terrestrial wireless communication device 210 may support at least one of, but not limited to, communication methods based on various communication standards such as Long-Term Evolution (LTE), global system for mobile communications (GSM), code-division multiple access (CDMA), or the like.

The terrestrial network 235 and the non-terrestrial network 215 may be independent of each other. Alternatively, the terrestrial network 235 and the non-terrestrial network 215 may be included in at least one network (e.g., a network provided by the same operator) that may be associated with each other.

The electronic device 101 may, when communication with the terrestrial network 235 may be unavailable or interrupted, perform wireless communication through the non-terrestrial network 215. Alternatively or additionally, the electronic device 101 may perform wireless communication through the non-terrestrial network 215 regardless of a communication state of the terrestrial network 235.

According to an embodiment, the electronic device 101 may include a processor 120, a display module 160 (e.g., a display), a wireless communication module 192 (e.g., a communication circuit), and/or an antenna module 197. For example, the processor 120 may be operatively, functionally, and/or electrically connected to the display module 160, the wireless communication module 192, and/or the antenna module 197.

According to an embodiment, the processor 120 may control overall operations related to communication with the terrestrial network 235 and/or communication with the non-terrestrial network 215. For example, the processor 120 may include a communication processor (e.g., the auxiliary processor 123 in FIG. 1) related to the terrestrial network communication and/or the non-terrestrial network communication.

According to an embodiment, the display module 160 may visually provide information processed in the electronic device 101 (e.g., the processor 120 and/or the wireless communication module 192). For example, the display module 160 may display a user interface (UI) (or graphic user interface (GUI)) related to the terrestrial network communication and/or the non-terrestrial network communication. As another example, the UI may display at least one of a type of network (e.g., cellular communication (third generation (3G), 4G, 5G), short-range communication (e.g., Bluetooth™, Institute of Electrical and Electronics Engineers (IEEE) 802.11 (e.g., 802.11a, 802.11b, 802.11g, 802.11n, 802.11ac, 802.11ax, or 802.11be), or Wireless-Fidelity (Wi-Fi)), or satellite communication), a type of network service provider (e.g., a satellite communication service provider, and an emergency service provider (ESP)), a strength of the network signal (e.g., signal strength bars, a received signal strength indicator (RSSI), a reference signal received power (RSRP)), a direction (e.g., an orientation, an elevation angle, or an azimuth angle), presence information of a communication device (e.g., a satellite) included in the network, or a state (e.g., idle, transmit, or receive) of the network communication.

For example, the UI indicating information related to the terrestrial network communication and/or the non-terrestrial network communication may include at least one of information about a service (e.g., a service for transmitting an emergency message) related to terrestrial and/or non-terrestrial networks, information about government offices, emergency contact information, a boilerplate phrase that may minimize text input from the user, and/or a method of questionnaires to communicate relatively quickly the emergency (e.g., guidance information such as the type of accident, location of injuries, and medical information), a messaging service (e.g., small message service (SMS), multimedia message service (MMS), rich communication service (RCS) messages, or the like), a voice call, a video call, a data communication service (e.g., information from various applications that provide data communication, including Internet browser apps), a location sharing service (e.g., longitude/latitude coordinates, map information related to the location of the non-terrestrial communication device 210, navigation, street view), and a UI related to a dialer and/or indicator. By way of example, an emergency message transmission service may include a series of operations to display SOS service state information related to whether the SOS service may be provided. By way of example, the medical information may include at least one of an age, a gender, a medical condition, or medication information.

For example, the UI indicating information related to the terrestrial network communication and/or the non-terrestrial network communication may not be limited to the examples described above and/or may be provided through another output device (e.g., the sound output module 155 in FIG. 1).

According to an embodiment, the wireless communication module 192 may support various types of wireless communication bands supportable by the electronic device 101. For example, the wireless communication bands may include, but not be limited to, short-range wireless communication bands (e.g., Bluetooth™, Bluetooth™ Low Energy (BLE), and Wi-Fi), terrestrial network (e.g., cellular network) communication bands, and/or non-terrestrial network bands (e.g., n255 band and/or n256 band). For example, the wireless communication band supportable by the electronic device 101 may not be limited to the embodiments described above.

For example, the wireless communication module 192 may perform non-terrestrial network wireless communication by using at least a portion of frequency bands related to the terrestrial network wireless communication.

According to an embodiment, the antenna module 197 may perform wireless communication with the non-terrestrial network 215 by using at least one antenna from among multiple antennas included in the antenna module 197. For example, the at least one antenna supporting the wireless communication with the non-terrestrial network 215 may include a dedicated antenna and/or a dual-purpose antenna. By way of example, the dedicated antenna may include an antenna supporting the non-terrestrial network 215. By way of example, the dual-purpose antenna may include an antenna supporting another type of network and the non-terrestrial network 215 together. For example, the dual-purpose antenna may include an antenna supporting a short-range communication network (e.g., Bluetooth™ network or wireless local area network (WLAN)) and/or the terrestrial network (e.g., LTE network or NR network).

For example, the electronic device 101 may communicate with at least one satellite (e.g., a GNSS satellite or a satellite for emergency messaging services) by using one non-terrestrial network dedicated antenna. For example, the electronic device 101 may support the non-terrestrial network wireless communication by using multiple antennas among the antennas supporting the terrestrial network 235.

As used herein, a satellite may be primarily referred to as the non-terrestrial wireless communication device 210. However, it is to be understood by those skilled in the art that when a satellite is referred to as providing wireless communication based on a specific radio access technology (RAT) (e.g., LTE and/or NR) or a specific function (e.g., a base station), this is by way of example and not limitation.

FIG. 2B is an example of a satellite network, according to an embodiment. Referring to FIG. 2B, the electronic device 101 may include and/or may be similar in many respects to the electronic device 101 described above with reference to FIGS. 1 and 2A, and may include additional features not mentioned above. Consequently, repeated descriptions of the electronic device 101 described above with reference to FIGS. 1 and 2A may be omitted for the sake of brevity.

As shown in FIG. 2B, the wireless communication system 200 may include at least one satellite 210 supporting wireless communication of the electronic device 101. For example, the satellite 210 may include multiple satellites at designated intervals traveling along a designated orbit 220.

According to an embodiment, the wireless communication system 200 may include at least one satellite gateway that may connect a satellite network by the satellite 210 to a public data network (e.g., the terrestrial network 235 or a terrestrial core network). For example, the satellite gateway may be and/or may include a base station (e.g., eNB or gNB) located on the ground to allow communication with the satellite 210. By way of example, the satellite network may be and/or may include a wirelessly connected network based on the satellite 210, which may also be referred to as a non-terrestrial network (NTN). For example, a terrestrial network (TN) may refer to a wirelessly connected network based on base stations located on the ground.

According to an embodiment, the satellite 210 may support registration into the satellite network for the electronic device 101 located in a service area (e.g., coverage) of the satellite 210. The satellite 210 may support wireless communication of the electronic device 101 registered in the satellite network. For example, the registration to the satellite network may include a series of operations of performing connection of the electronic device 101 to the satellite 210.

According to an embodiment, the electronic device 101 may perform registration to the satellite network through the satellite 210 when the satellite 210 is detected through a search (or scan) related to the satellite 210. For example, the electronic device 101 may identify (configure or determine) a time point of transmitting a satellite signal based on the connection information of the satellite 210. In an embodiment, the electronic device 110 may transmit a signal (e.g., a random-access channel (RACH) preamble) related to registration into the satellite network to the satellite 210 based on the time point of transmitting the satellite signal. For example, the electronic device 101 may identify (configure or determine) transmission power of a satellite signal to the satellite 210 based on the connection information of the satellite 210. The electronic device 110 may transmit a signal related to registration into the satellite network to the satellite 210 based on the transmission time point and transmission power of the satellite signal.

In an embodiment, the electronic device 101 may identify (configure or determine) a transmission interval of a satellite signal based on the connection information of the satellite 210. The electronic device 110 may periodically transmit a signal to the satellite 210 based on the transmission interval of the satellite signal. For example, the connection information of the satellite 210 may include information related to at least one of a time point of transmitting a signal to the satellite 210 at the previous time point, a communication quality at the time point of transmitting the signal to the satellite 210, a time point of connecting to the satellite 210 at the previous time point, a communication quality at the time point of connecting to the satellite 210, a maximum communication quality of a signal received from the satellite 210 at the previous time point, a time point of disconnecting from the satellite 210 at the previous time point, or a communication quality at the time point of disconnecting from the satellite 210 at the previous time point. For example, the communication quality may include at least one of a received signal strength indicator (RSSI), a reference signal received quality (RSRQ), reference signal received power (RSRP), a signal to interference and noise ratio (SINR), or a bit error rate (BER).

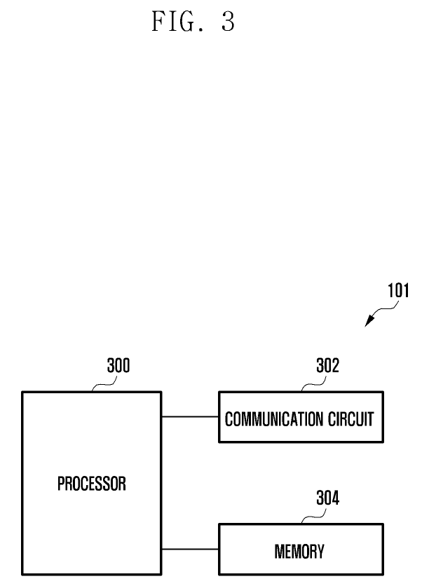

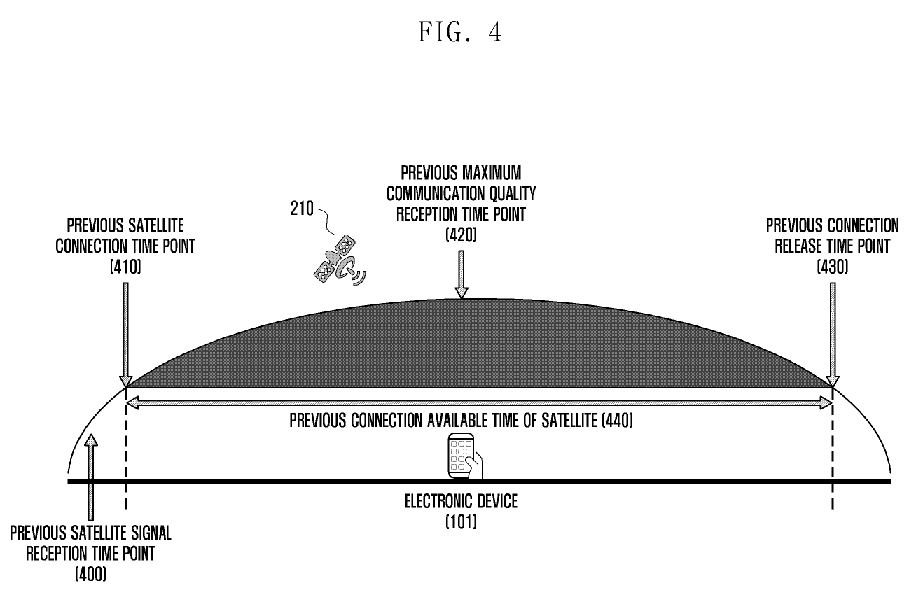

FIG. 3 is a block diagram illustrating an electronic device for performing satellite communications, according to an embodiment. Referring to FIG. 3, the electronic device 101 may include and/or may be similar in many respects to electronic device 101 described above with reference to FIGS. 1, 2A and 2B, and may include additional features not mentioned above. For example, at least a portion of FIG. 3 is described with reference to FIG. 4. FIG. 4 is an example of connection information of a satellite acquired by an electronic device, according to an embodiment.

As shown in FIGS. 3 and 4, the electronic device 101 may include a processor 300 (e.g., including processing circuitry), a communication circuit 302 (or communication circuitry), and/or memory 304. For example, the processor 300 may include and/or may be similar in many respects to the processor 120 described above with reference to FIGS. 1 and 2A, and may include additional features not mentioned above. For example, the processor 300 may include a communication processor (e.g., the auxiliary processor 123 in FIG. 1). The communication circuit 302 may include and/or may be similar in many respects to the wireless communication module 192 described above with reference to FIGS. 1 and 2A, and may include additional features not mentioned above. The memory 304 may include and/or may be similar in many respects to the memory 130 described above with reference to FIG. 1, and may include additional features not mentioned above. For example, the processor 300 may be operatively, functionally, and/or electrically connected to the communication circuit 302 and/or the memory 304. For example, the processor 300, according to an embodiment, may include at least one processor.

According to an embodiment, the processor 300 may identify connection information related to the satellite 210 when the satellite 210 is detected through a search (or scan) related to the satellite 210. By way of example, the connection information related to the satellite 210 may include information acquired (or received) by the electronic device 101 through connection with the satellite 210 at the previous time point. By way of example, the connection information related to the satellite 210 may include information acquired (or received) by the electronic device 101 through connection with a satellite (or another satellite) traveling (or orbiting) along an orbit substantially similar and/or the same as that of the satellite 210 at the previous time point. For example, the connection information related to the satellite 210 may be and/or may include information corresponding to a change in communication quality due to a change in distance of the electronic device 101 from the satellite 210 traveling along a designated travel path (e.g., orbit 220) at the previous time point and may include information related to a time point 400 (e.g., an initial reception time point) at which the electronic device 101 receives a signal from the satellite 210 at the previous time point, a communication quality at a time point 400 at which the electronic device 101 receives a signal from the satellite 210, a time point 410 (e.g., the initial connection time point) at which the electronic device 101 is connected to the satellite 210 at the previous time point, a communication quality at a time point 410 at which the electronic device 101 is connected to the satellite 210, a point in time 420 at which the electronic device 101 acquires (or receives) a signal having a maximum communication quality from the satellite 210 at the previous time point, a maximum communication quality of a signal received from the satellite 210, a time point 430 at which the electronic device 101 disconnects from the satellite 210 at the previous time point, or a communication quality at a time point 430 at which the electronic device 101 disconnects from the satellite 210. For example, the search related to the satellite may identify (or determine) the existence of a satellite to which the electronic device 101 may connect (or access), and may include a series of operations to determine if a satellite signal exceeding a designated quality exists. For example, the designated quality may include a minimum communication quality that may be determined to be such that the electronic device 101 is able to restore (or decode) the signal received by the electronic device 101 from the satellite 210. For example, the time point 410 at which the electronic device 101 is connected to the satellite 210 at the previous time point may include a time point at which the electronic device 101 had a radio resource control (RRC) connection established with the satellite 210 at the previous time point.

By way of example, the processor 300 may, when the satellite 210 has been detected, identify whether a power saving mode related to the satellite 210 has been configured. For example, the power saving mode related to the satellite 210 may include an operation mode for configuring a time point at which a signal is transmitted to the satellite 210 based on the connection information related to the satellite 210.

For example, the processor 300 may, when the power saving mode related to the satellite 210 is configured, identify whether connection information related to the satellite 210 detected through a search related to the satellite 210 is present in the memory 304. By way of example, the operation of identifying that connection information related to the satellite 210 is present in the memory 304 may include a series of operations of identifying that connection information related to the satellite 210 is stored in the memory 304 that corresponds to satellite information (e.g., orbit information of the satellite 210 and/or identification information of the satellite 210) acquired from control information (e.g., system information block (SIB)) acquired from the satellite 210. For example, the identification information of the satellite 210 may include at least one of a physical cell identity (PCI), an absolute radio frequency channel number (ARFCN), a cell ID, a mobile country code (MCC), and/or a mobile network code (MNC) related to the satellite 210. By way of example, the operation of identifying that connection information related to the satellite 210 is present in the memory 304 may include a series of operations of identifying whether connection information related to the satellite 210 detectable at the location of the electronic device 101 is stored in the memory 304 based on operation information (e.g., an orbit period and/or orbit information of the satellite) of satellites stored in the memory 304.

For example, the processor 300 may, when the connection information related to the satellite 210 is present in the memory 304, acquire the connection information related to the satellite 210 from the memory 304.

As another example, the processor 300 may, when the connection information related to the satellite 210 is not present in the memory 304, control the communication circuit 302 to perform connection with the satellite 210. The processor 300 may store in the memory 304 connection information related to the satellite 210 that may be acquired (or received) through the connection with the satellite 210. By way of example, the connecting with the satellite 210 may include a series of operations (e.g., a RACH procedure) for the electronic device 101 to transmit a RACH preamble to the satellite 210 and receive a RACH response from the satellite 210, and a series of operations for establishing RRC with the satellite 210.

According to an embodiment, the processor 300 may identify (configure or determine) a time point (e.g., a signal transmission time point) for transmitting a signal to the satellite 210 based on the connection information related to the satellite 210. For example, the processor 300 may configure the time point for transmitting the satellite signal based on the communication quality at the time point 410 at which the electronic device 101 is connected to the satellite 210 at the previous time point. For example, the processor 300 may determine, as the time point of transmitting the satellite signal, a time point at which the communication quality of the signal received from the satellite 210 reaches a designated first reference quality configured based on the communication quality at the time point 410 at which the electronic device 101 is connected to the satellite 210 at the previous time point. By way of example, the designated first reference quality may be configured based on the communication quality at the previous time point 410 at which the electronic device 101 is connected to the satellite 210 and a designated first offset. For example, the designated first offset may be configured based on a maximum communication quality of a signal received by the electronic device 101 from the satellite 210 at the previous time point. For example, the signal received from the satellite 210 may include at least one of a synchronization signal block (SSB) or a channel state information (CSI)-reference signal (RS). For example, the signal received from the satellite 210 may include at least one of a synchronization signal, a preamble signal, or a broadcast signal.

For example, the processor 300 may configure the time point for transmitting the satellite signal based on the time point 400 at which the electronic device 101 receives the signal from the satellite 210 at the previous time point and the time point 410 at which the electronic device 101 is connected to the satellite 210 at the previous time point. For example, the processor 300 may determine a time point at which a designated first reference time elapses from the time point of detection of the satellite 210 as the time point for transmitting the satellite signal. For example, the designated first reference time may be configured based on a difference value between the time point 400 at which the electronic device 101 receives the signal from the satellite 210 at the previous time point and the time point 410 at which the electronic device 101 is connected to the satellite 210 at the previous time point and a designated second offset. By way of example, the designated second offset may be configured based on a transmission delay (e.g., transmission delay/2) between the electronic device 101 and the satellite 210. For example, the time point of detection of the satellite 210 may include a time point (e.g., an initial reception time point) of receiving a satellite signal from the satellite 210 that may exceed a designated quality threshold.

For example, the processor 300 may configure the time point for transmitting the satellite signal based on a communication quality at the time point 400 at which the electronic device 101 receives the signal from the satellite 210 at the previous time point and a communication quality at the time point 410 at which the electronic device 101 is connected to the satellite 210 at the previous time point. By way of example, the processor 300 may determine a time point at which the communication quality of the signal received (or acquired) from the satellite 210 is improved by the designated second reference quality over the communication quality at the time of detection of the satellite 210 as the time point for transmitting the satellite signal. For example, the designated second reference quality may be configured based on a difference value between the communication quality at the time point 400 at which the electronic device 101 receives the signal from the satellite 210 at the previous time point and the communication quality at the time point 410 at which the electronic device 101 is connected to the satellite 210 at the previous time point and a designated third offset. For example, the designated third offset may be configured based on the maximum communication quality of the signal received by the electronic device 101 from the satellite 210 at the previous time point and may be the same as or different from the designated first offset.

For example, the processor 300 may configure the time point for transmitting the satellite signal based on the maximum communication quality of the signal received by the electronic device 101 from the satellite 210. For example, the processor 300 may determine, as the time point of transmitting the satellite signal, a time point at which the communication quality of the signal received from the satellite 210 reaches a designated third reference quality configured based on the maximum communication quality at the signal acquired (or received) by the electronic device 101 from the satellite 210 at the previous time point. By way of example, the designated third reference quality may be configured based on the maximum communication quality of the signal acquired by the electronic device 101 from the satellite 210 at the previous time point and a designated fourth offset. For example, the designated fourth offset may be configured based on the maximum communication quality of the signal received by the electronic device 101 from the satellite 210 at the previous time point and may be the same as or different from the designated first offset and/or the designated third offset.

For example, the processor 300 may configure the time point for transmitting the satellite signal based on the time point 420 at which the electronic device 101 receives a signal having a maximum communication quality from the satellite 210. For example, the processor 300 may determine a time point at which a designated second reference time elapses from the time point of detection of the satellite 210 as the time point for transmitting the satellite signal. By way of example, the designated second reference time may be configured based on the time point 420 at which the electronic device 101 acquires (or receives) a signal having a maximum communication quality from the satellite 210 at the previous time point and a designated fifth offset. For example, the designated fifth offset may be configured based on a difference value between the time point 410 at which the electronic device 101 is connected to the satellite 210 at the previous time point and the time point 420 at which the signal having a maximum communication quality is acquired from the satellite 210.

According to an embodiment, the processor 300 may identify (or configure) transmission power for transmitting a signal to the satellite 210 based on the connection information related to the satellite 210. For example, the processor 300 may identify that a designated power configuration condition is satisfied based on at least one of a maximum communication quality of a signal received from the satellite 210 at the previous time point and/or a connection available time with the satellite 440 acquired at the previous time point.

For example, the processor 300 may, based on determining that the designated power configuration condition is not satisfied, configure relatively high power (e.g., the maximum transmission power) as the transmission power of the signal within a range that may be supported by the electronic device 101. By way of example, a state in which the designated power configuration condition is not satisfied may include a state in which the maximum communication quality acquired at the previous time point is less than or equal to the designated fifth reference quality, and/or a state in which the connection available time with the satellite 440 at the previous time point is less than or equal to the designated third reference time.

For example, if the designated power configuration condition is satisfied, the processor 300 may configure the transmission power of the signal based on the communication quality at the time point 410 at which the electronic device 101 is connected to the satellite 210 at the previous time point and the communication quality at the time point for the electronic device 101 to transmit the signal to the satellite 210. For example, the transmission power of the signal may be configured based on a maximum transmission power supportable by the electronic device 101 and a designated fourth reference quality. For example, the designated fourth reference quality may be configured based on a difference value between the communication quality at the time point 410 at which the electronic device 101 is connected to the satellite 210 at the previous time point and the communication quality at the time point for the electronic device 101 to transmit a signal to the satellite 210. By way of example, a state in which the designated power configuration condition is satisfied may include a state in which the maximum communication quality acquired at the previous time point exceeds the designated fifth reference quality, and/or a state in which the connection available time with the satellite 440 at the previous time point exceeds the designated third reference time.

According to an embodiment, the processor 300 may control the communication circuit 302 to transmit a signal to the satellite 210 when a time point to transmit a signal to the satellite 210 arrives. For example, the processor 300 may control the communication circuit 302 to transmit a RACH preamble for connection with the satellite 210 when a time point to transmit a signal to the satellite 210 arrives.

According to an embodiment, the processor 300 may control the communication circuit 302 to transmit a signal to the satellite 210 based on an interval configured based on the connection information related to the satellite 210. For example, the processor 300 may control the communication circuit 302 to transmit the signal to the satellite 210 based on a designated first interval if the signal is predicted to have a relatively low probability of reaching the satellite 210 before the time point for transmitting a signal to the satellite 210 arrives. For example, the designated first interval may be configured (or varied) such that a relatively lower quality signal received from the satellite 210 results in a relatively wider (or longer) transmission interval for the signal. For example, the processor 300 may, when the time point for transmitting a signal to the satellite 210 arrives, control the communication circuit 302 to transmit the signal to the satellite 210 based on a designated second interval configured to be shorter than the first designated first interval if the signal is predicted to have a relatively high probability of reaching the satellite 210. For example, the processor 300 may control the communication circuit 302 to restrict transmission of the signal to the satellite 210 if the signal is predicted to have a relatively low probability of reaching the satellite 210 before the time point for transmitting a signal to the satellite 210 arrives.

According to an embodiment, the processor 300 may selectively perform connection with the satellite based on the connection restriction list related to the satellite. For example, the processor 300 may add, to the connection restriction list related to the satellite, a satellite with which the electronic device 101 has failed to connect at the previous time point, or a satellite that has the connection available time with the satellite 440 with the electronic device 101 satisfying a designated connection restriction condition. For example, the satellite satisfying the designated connection restriction condition may include a satellite having the connection available time with the satellite 440 with the electronic device 101 equal to or less than a designated minimum reference time. By way of example, the connection restriction list related to the satellite may include at least some of satellite information (e.g., orbit information of the satellite and/or identification information of the satellite) related to the satellite to which connection of the electronic device 101 is restricted.

For example, the processor 300 may, based on the satellite detected through the search related to the satellite being included in the connection restriction list related to the satellite, restrict a connection to a satellite. For example, the operation of restricting the connection to the satellite may include a series of operations of restricting transmission of a RACH preamble or RRC connection request message for the connection with the satellite.

For example, the processor 300 may, based on the satellite detected through the search related to the satellite not being included in the connection restriction list related to the satellite, control the communication circuit 302 to perform connection to the corresponding satellite.

According to an embodiment, the communication circuit 302 may allow the electronic device 101 to transmit and/or receive a signal and/or data to and/or from the satellite 210. According to an embodiment, the communication circuit 302 may transmit and/or receive a signal and/or data to and/or from at least one external electronic device (e.g., the electronic device 102 or 104 or the server 108 in FIG. 1) included in the terrestrial network 235.

According to an embodiment, the memory 304 may store various data used by at least one component (e.g., the processor 300 and/or the communication circuit 302) of electronic device 101. For example, the data may include the connection information related to the satellite 210. According to an embodiment, the memory 304 may store various instructions which may be executed through the processor 300. By way of example, the instructions may be executed by the processor 300 (e.g., at least one processor) individually or collectively.

According to an embodiment, an electronic device (e.g., the electronic device 101) may include a memory (e.g., the memory 130 or the memory 304), a communication circuit (e.g., the wireless communication module 192 or the communication circuit 302), and at least one processor (e.g., the processor 120 or the processor 300) operatively connected to the memory and the communication circuit. According to an embodiment, the processor may, based on detecting a satellite (e.g., the satellite 210), identify whether connection information related to the satellite exists in the memory. According to an embodiment, the processor may, based on the connection information related to the satellite existing (e.g., being present) in the memory, identify (or determine) a time point for transmitting a signal to the satellite, based on the connection information. According to an embodiment, the processor may transmit a signal to the satellite based on the time point for transmitting a signal to the satellite.

According to an embodiment, the at least one processor may configure (or determine) a time point for transmitting a signal to a satellite based on a communication quality at a time point at which the electronic device 101 is connected to the satellite at a previous time point.

According to an embodiment, the at least one processor may configure (or determine) a time point for transmitting a signal to a satellite based on a difference between a time point at which the electronic device 101 receives the signal from the satellite at the previous time point and a time point at which the electronic device 101 is connected to the satellite.

According to an embodiment, the at least one processor may configure (or determine) a time point for transmitting a signal to a satellite based on a difference between a communication quality at the time point at which the electronic device 101 receives the signal from the satellite at the previous time point and a communication quality at the time point at which the electronic device 101 is connected to the satellite.

According to an embodiment, the at least one processor may configure (or determine) a time point for transmitting a signal to a satellite based on a maximum communication quality of a signal received by the electronic device 101 from the satellite at the previous time point.

According to an embodiment, the at least one processor may configure (or determine) a time point for transmitting a signal to a satellite based on a time point at which the electronic device 101 receives a signal having the maximum communication quality from the satellite at the previous time point.

According to an embodiment, the at least one processor may configure (or determine) transmission power of the signal to be transmitted to the satellite based on the connection information related to the satellite and the communication quality at the time point for transmitting a signal to the satellite, and transmit the signal to the satellite based on the identified time point for transmitting a signal to the satellite and the configured transmission power.

According to an embodiment, the at least one processor may, based on the connection information related to the satellite not being present in the memory, perform connection to the satellite and store connection information acquired through the connection with the satellite.

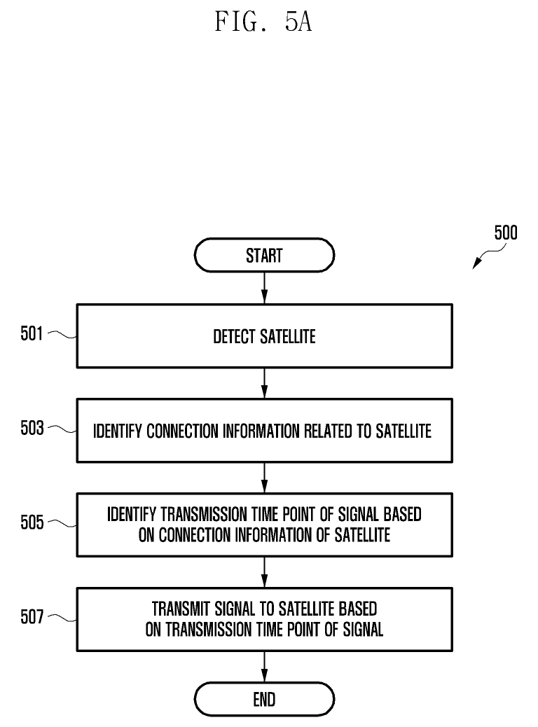

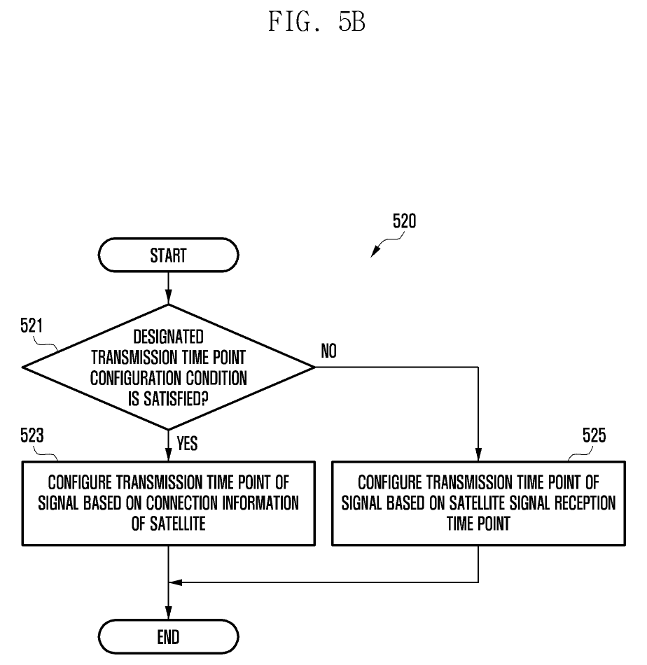

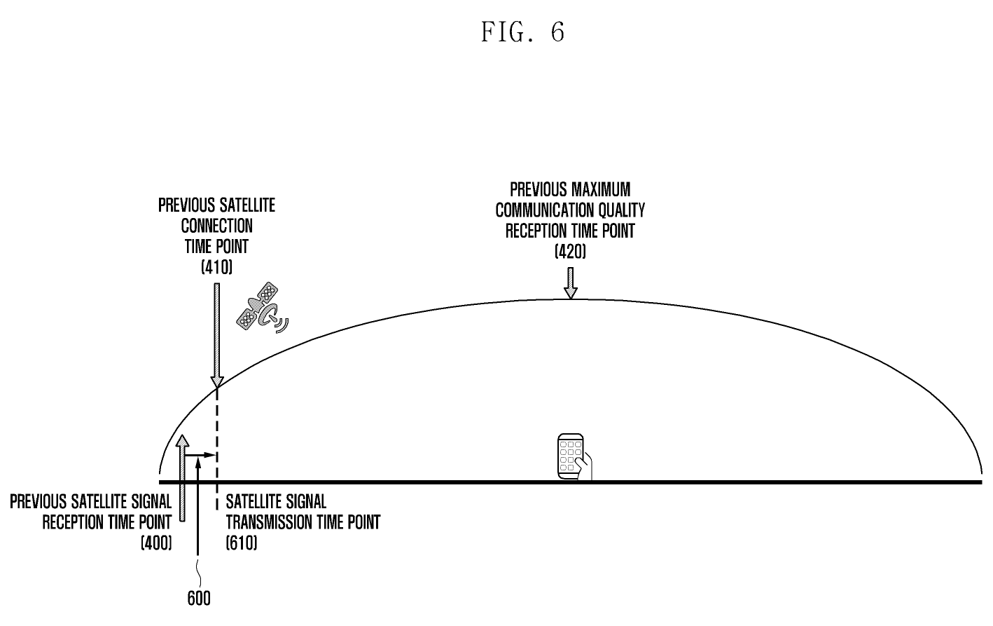

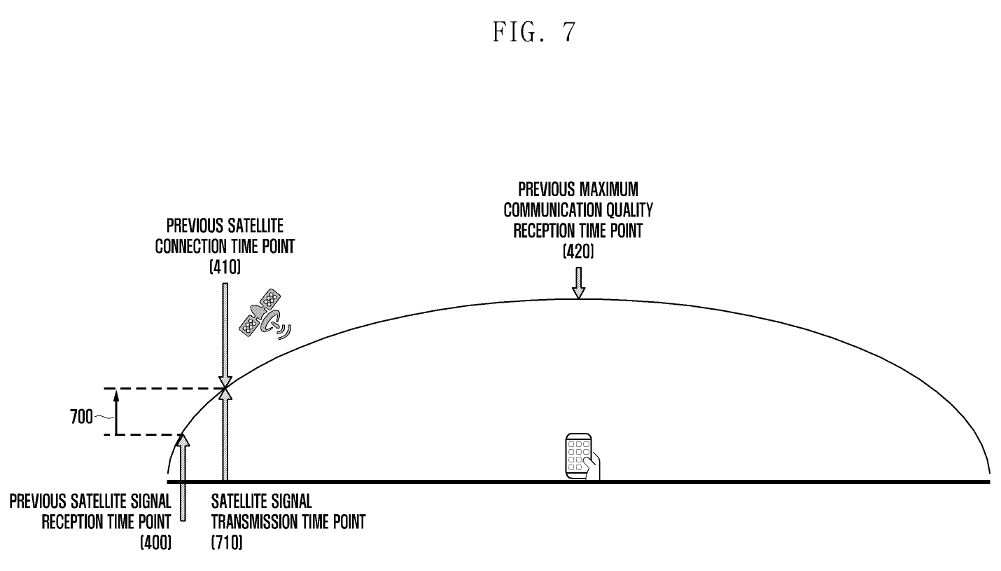

FIG. 5A is a flowchart 500 for configuring a transmission time point of a signal in an electronic device, according to an embodiment. In the flowchart 500, respective operations may be sequentially performed, but may not be necessarily performed sequentially. For example, the sequential position of each operation may be changed, or at least two operations may be performed in parallel. In an embodiment, the operations of flowchart 500 may be performed by the electronic device 101 as described above with reference to FIGS. 1, 2A, 2B, 3 and 4. At least a portion of FIG. 5A may be described with reference to FIGS. 6 and 7. FIG. 6 is an example of configuring a transmission time point of a signal in an electronic device, according to an embodiment. FIG. 7 is an example of configuring a transmission time point of a signal in an electronic device, according to an embodiment.

Referring to FIGS. 5A, 6 and 7, an electronic device 101 (e.g., the processor 120 or the processor 300) may, in operation 501, detect a satellite 210 to which the electronic device 101 may be connected (or registered) through a search (or scan) related to the satellite 210. For example, the search related to the satellite 210 may be and/or may include identifying the existence of a satellite to which the electronic device 101 may connect (or access), and may include a series of operations to determine if a satellite signal exceeding a designated quality exists. For example, the designated quality may include a minimum communication quality that may be determined to be such that the electronic device 101 may be able to restore (or decode) the signal received by the electronic device 101 from the satellite 210.

According to an embodiment, the electronic device 101 (e.g., the processor 120 or 300) may, in operation 503, identify connection information related to the satellite 210 detected through a search (or scan) related to the satellite 210. By way of example, the connection information related to the satellite 210 may include information acquired (or received) by the electronic device 101 through connection with the satellite 210 at the previous time point. By way of example, the connection information related to the satellite 210 may include information acquired (or received) by the electronic device 101 through connection with a satellite (or another satellite) traveling (or orbiting) along an orbit substantially similar and/or the same as that of the satellite 210 at the previous time point. For example, the connection information related to the satellite 210 may be and/or may include information corresponding to a change in communication quality due to a change in distance of the electronic device 101 from the satellite 210 traveling along a designated travel path (e.g., the orbit 220 in FIG. 2) at the previous time point and may include information related to a time point 400 (e.g., an initial reception time point) at which the electronic device 101 receives a signal from the satellite 210 at the previous time point, a communication quality at a time point 400 at which the electronic device 101 receives a signal from the satellite 210, a time point 410 (e.g., the initial connection time point) at which the electronic device 101 is connected to the satellite 210 at the previous time point, a communication quality at a time point 410 at which the electronic device 101 is connected to the satellite 210, a point in time 420 at which the electronic device 101 acquires (or receives) a signal having a maximum communication quality from the satellite 210 at the previous time point, a maximum communication quality of a signal received from the satellite 210, a time point 430 at which the electronic device 101 disconnects from the satellite 210 at the previous time point, or a communication quality at a time point 430 at which the electronic device 101 disconnects from the satellite 210. For example, the time point 410 at which the electronic device 101 receives the signal from the satellite 210 may include a time point at which the electronic device 101 first receives a signal exceeding a designated quality from the satellite 210. For example, the time point 410 at which the electronic device 101 is connected to the satellite 210 at the previous time point may include a time point at which the electronic device 101 had a radio resource control (RRC) connection established with the satellite 210 at the previous time point.

By way of example, the processor 300 may, when the satellite 210 has been detected, identify whether a power saving mode related to the satellite 210 has been configured. For example, the power saving mode related to the satellite 210 may include an operation mode for configuring a time point for transmitting a signal to the satellite 210 and/or signal transmission power by which a signal is transmitted to the satellite 210 based on the connection information related to the satellite 210. For example, the operation of identifying whether the power saving mode related to the satellite 210 is configured may be omitted when the power saving mode related to the satellite 210 is configured as a default operation.

For example, the processor 300 may, based on the power saving mode related to the satellite 210 being configured, identify whether connection information related to the satellite 210 detected through a search related to the satellite 210 is present in the memory 304. For example, the processor 300 may identify that connection information corresponding to satellite information (e.g., the orbit information of the satellite 210 and/or the identification information of the satellite 210) acquired from control information (e.g., SIB) received from the satellite 210 or operation information (e.g., the orbital period and/or orbital information of the satellite 210) of the satellites stored in the memory 304 is stored in the memory 304. For example, the identification information of the satellite 210 may include at least one of a physical cell identity (PCI), an absolute radio frequency channel number (ARFCN), a cell ID, a mobile country code (MCC), and/or a mobile network code (MNC) related to the satellite 210.

For example, the processor 300 may, when the connection information related to the satellite 210 is present in the memory 304, acquire (or identify) the connection information related to the satellite 210 from the memory 304.

As another example, the processor 300 may, when the connection information related to the satellite 210 is not present in the memory 304, control the communication circuit 302 to perform connection with the satellite 210. The processor 300 may store in the memory 304 connection information related to the satellite 210 that is acquired through the connection with the satellite 210. By way of example, the connecting with the satellite 210 may include a series of operations (e.g., a RACH procedure) for the electronic device 101 to transmit a RACH preamble to the satellite 210 and receive a RACH response from the satellite 210, and a series of operations for establishing RRC with the satellite 210.

According to an embodiment, the electronic device 101 (e.g., the processor 120 or 300) may, in operation 505, identify (or configure) a time point (e.g., a signal transmission time point) for transmitting a signal to the satellite 210 based on the connection information related to the satellite 210. For example, the processor 300 may continuously and/or periodically identify a communication quality of a signal received from the satellite 210. The processor 300 may, as shown in FIG. 6, determine, as the satellite signal transmission time point 610 for transmitting the satellite signal, a time point at which the communication quality of the signal received from the satellite 210 reaches a designated first reference quality configured based on the communication quality at the time point 410 at which the electronic device 101 is connected to the satellite 210 at the previous time point. For example, the designated first reference quality may be configured (or determined) based on the communication quality at the time point 410 at which the electronic device 101 is connected to the satellite 210 at the previous time point, or the communication quality at the time point 410 at which the electronic device 101 is connected to the satellite 210 at the previous time point and a designated first offset. For example, the designated first offset may be configured based on a maximum communication quality of a signal received by the electronic device 101 from the satellite 210 at the previous time point.

For example, the processor 300 may determine a satellite signal transmission time point 610 at which a designated first reference time elapses from the time point of detection of the satellite 210 as the time point for transmitting the satellite signal. By way of example, the designated first reference time may be configured based on a difference value 600 between the time point 400 at which the electronic device 101 receives a signal from the satellite 210 at the previous time point and the time point 410 at which the electronic device 101 is connected to the satellite 210 at the previous time point, or the difference value 600 between the time point 400 at which the electronic device 101 receives a signal from the satellite 210 at the previous time point and the time point 410 at which the electronic device 101 is connected to the satellite 210 at the previous time point and a designated second offset. By way of example, the designated second offset may be configured based on a transmission delay (e.g., transmission delay/2) between the electronic device 101 and the satellite 210. For example, the time point of detection of the satellite 210 may include a time point (e.g., an initial reception time point) of receiving a satellite signal from the satellite 210 that exceeds a designated quality.

For example, the processor 300 may continuously or periodically identify a communication quality of a signal received from the satellite 210. The processor 300 may, as shown in FIG. 7, determine a time point at which the communication quality of the signal received (or acquired) from the satellite 210 is improved by the designated second reference quality over the communication quality at the time of detection of the satellite 210 as the satellite signal transmission time point 710 for transmitting the satellite signal. By way of example, the designated second reference time may be configured based on a difference value 700 between a communication quality at the time point 400 at which the electronic device 101 receives a signal from the satellite 210 at the previous time point and a communication quality at the time point 410 at which the electronic device 101 is connected to the satellite 210 at the previous time point, wherein the difference value being generated due to a change in communication quality according to a change in distance between the satellite 210 traveling over a designated travel path (e.g., the orbit 220 in FIG. 2) and the electronic device 101, or the difference value 700 between the communication quality at the time point 400 at which the electronic device 101 receives a signal from the satellite 210 at the previous time point and the communication quality at the time point 410 at which the electronic device 101 is connected to the satellite 210 at the previous time point and a designated third offset. For example, the designated third offset may be configured based on the maximum communication quality of the signal received by the electronic device 101 from the satellite 210 at the previous time point and may be the same as or different from the designated first offset.

For example, the processor 300 may continuously and/or periodically identify a communication quality of a signal received from the satellite 210. The processor 300 may determine, as the time point of transmitting the satellite signal, a time point at which the communication quality of the signal received from the satellite 210 reaches a designated third reference quality configured based on the maximum communication quality at the signal acquired by the electronic device 101 from the satellite 210 at the previous time point. By way of example, the designated third reference quality may be configured based on a difference value between the maximum communication quality of the signal acquired by the electronic device 101 from the satellite 210 at the previous time point and a designated fourth offset. For example, the designated fourth offset may be configured based on the maximum communication quality of the signal received by the electronic device 101 from the satellite 210 at the previous time point and may be the same as or different from the designated first offset and/or the designated third offset.

For example, the processor 300 may determine a time point at which a designated second reference time elapses from the time point of detection of the satellite 210 as the time point for transmitting the satellite signal. By way of example, the designated second reference time may be configured based on a difference value between the time point 420 at which the electronic device 101 acquires a signal having a maximum communication quality from the satellite 210 at the previous time point and a designated fifth offset. For example, the designated fifth offset may be configured based on a difference value between the time point 410 at which the electronic device 101 is connected to the satellite 210 at the previous time point and the time point 420 at which the electronic device 101 acquires the signal having a maximum communication quality from the satellite 210 at the previous time point.

According to an embodiment, the electronic device 101 (e.g., the processor 120 or 300) may, in operation 507, transmit a signal to the satellite 210 based on the time point for transmitting a signal to the satellite 210. For example, the processor 300 may control the communication circuit 302 to transmit a RACH preamble for connection with the satellite 210 when a time point for transmitting a signal to the satellite 210 configured based on the connection information related to the satellite 210 arrives.

According to an embodiment, the electronic device 101 (e.g., the processor 120 or 300) may receive a RACH response signal from the satellite 210 as a response for the RACH preamble. The electronic device 101 (e.g., the processor 120 or 300) may, based on receiving the RACH response signal, transmit an RRC connection request message to the satellite 210. The electronic device 101 (e.g., the processor 120 or 300) may, based on receiving an RRC connection setup message as a response for the RRC connection request message, determine that the RRC connection with the satellite 210 is completed. The electronic device 101 (e.g., the processor 120 or 300) may transmit an RRC connection setup complete message to the satellite 210 based on the determination that the RRC connection with the satellite 210 is complete. For example, the time point for connection to the satellite 210 may include a time point at which the message indicating the RRC connection setup with the satellite 210 is completed is transmitted.

According to an embodiment, the electronic device 101 (e.g., the processor 120 or 300) may, when the connection information related to the satellite 210 is present in the memory 304, update the connection information related to the satellite 210 stored in the memory 304 based on the connection information related to the satellite 210 newly acquired (or received) through connection with the satellite 210.

FIG. 5B is a flowchart 520 for selectively configuring a transmission time point of a signal in an electronic device 101 based on connection information of a satellite, according to an embodiment. According to an embodiment, at least a portion of FIG. 5B may include a detailed operation of operation 505 in FIG. 5. In the flowchart 520, respective operations may be sequentially performed, but may not be necessarily performed sequentially. For example, the sequential position of each operation may be changed, or at least two operations may be performed in parallel. In an embodiment, the operations of flowchart 520 may be performed by the electronic device 101 as described above with reference to FIGS. 1, 2A, 2B, 3, 4 and 5A.

According to an embodiment referring to FIG. 5B, the electronic device 101 (e.g., the processor 120 in FIG. 1 or the processor 300 in FIG. 3) may, when the connection information related to the satellite 210 is identified (e.g., operation 503 in FIG. 5A), in operation 521, identify whether the connection information related to the satellite 210 satisfies a designated transmission time point configuration condition. For example, the processor 300 may, based on the maximum communication quality acquired at the previous time point being less than or equal to the designated fifth reference quality, or the connection available time with the satellite 440 at the previous time point being less than or equal to the designated third reference time, or the difference value between the time point 400 at which the electronic device 101 detects the satellite 210 at the previous time point and the time point 410 at which the electronic device 101 is connected to the satellite 210 at the previous time point exceeding the designated fifth reference time, determine that the designated transmission time point configuration condition is not satisfied.

As another example, the processor 300 may, based on the maximum communication quality acquired at the previous time point exceeding the designated fifth reference quality, or the connection available time with the satellite 440 at the previous time point exceeding the designated third reference time, or the difference value between the time point 400 at which the electronic device 101 detects the satellite 210 at the previous time point and the time point 410 at which the electronic device 101 is connected to the satellite 210 at the previous time point being less than or equal to the designated fifth reference time, determine that the designated transmission time point configuration condition is satisfied.

By way of example, the designated fifth reference quality may include a minimum communication quality configured to determine whether the transmission power of the satellite signal is configured based on the connection information related to the satellite 210. By way of example, the designated third reference time may include a designated minimum reference time configured to determine whether the transmission power of the satellite signal is configured based on the connection information related to the satellite 210. For example, the designated fifth reference time may represent a reference time point configured to determine whether the designated transmission configuration condition is satisfied based on the time point 400 at which the electronic device 101 detects the satellite 210 at the previous time point and the time point 410 at which the electronic device 101 is connected to the satellite 210 at the previous time point.

According to an embodiment, the electronic device 101 (e.g., the processor 120 or 300) may, based on determining that the connection information related to the satellite 210 satisfies the designated transmission time point configuration condition (e.g., “YES” in operation 521), in operation 523, configure a time point for transmitting a signal to the satellite 210 based on the connection information related to the satellite 210.

According to an embodiment, the electronic device 101 (e.g., the processor 120 or 300) may, based on determining that the connection information related to the satellite 210 does not satisfy the designated transmission time point configuration condition (e.g., “NO” in operation 521), in operation 525, configure a time point for transmitting a signal to the satellite 210 based on the time point of receiving the signal from the satellite 210.

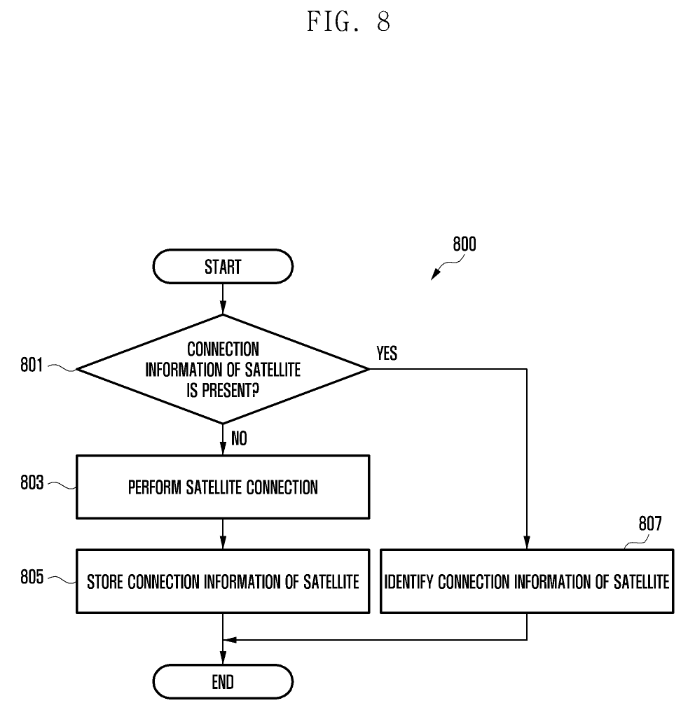

FIG. 8 is flowchart 800 for acquiring connection information of a satellite by an electronic device, according to an embodiment. According to an embodiment, at least a portion of FIG. 8 may include a detailed operation of operation 503 in FIG. 5A. In the flowchart 800, respective operations may be sequentially performed, but may not necessarily be performed sequentially. For example, the sequential position of each operation may be changed, or at least two operations may be performed in parallel. In an embodiment, the operations of flowchart 800 may be performed by the electronic device 101 as described above with reference to in FIGS. 1, 2A, 2B, 3, 4, 5A, 5B, 6 and 7.

Referring to FIG. 8, the electronic device 101 (e.g., the processor 120 in FIG. 1 or the processor 300 in FIG. 3) may, based on detecting (or identifying) the satellite 210 to which the electronic device 101 may be connected (or registered) (e.g., similarly to operation 501 in FIG. 5A), in operation 801, identify whether the connection information of the satellite 210 is present in the electronic device 101. For example, the processor 300 may identify whether the connection information of the satellite 210 is present in the memory 304 based on satellite information (e.g., the orbit information of the satellite 210 and/or the identification information of the satellite 210) acquired from control information (e.g., SIB) received from the satellite 210. For example, the processor 300 may identify whether the connection information of the satellite 210 is present in the memory 304 based on a location of the electronic device 101 and the operation information (e.g., the orbital period and orbital information of satellites) of satellites stored in the memory 304. For example, the identification information of the satellite 210 may include at least one of a physical cell identity (PCI), an absolute radio frequency channel number (ARFCN), a cell ID, a mobile country code (MCC), and/or a mobile network code (MNC) related to the satellite 210.

According to an embodiment, the electronic device 101 (e.g., the processor 120 or 300) may, based on determining that the connection information related to the satellite 210 is not present in the electronic device 101 (e.g., “NO” in operation 801), in operation 803, perform connection to the satellite 210. For example, the processor 300 may control the communication circuit 302 to transmit a RACH preamble to the satellite 210 in response to the detection of the satellite 210. The processor 300 may, based on receiving a RACH response signal from the satellite 210 in response to the RACH preamble, control the communication circuit 302 to transmit an RRC connection request message to the satellite 210. The processor 300 may, based on receiving an RRC connection setup message in response to the RRC connection request message, determine that the RRC connection with the satellite 210 is completed. The processor 300 may control the communication circuit 302 to transmit an RRC connection setup complete message to the satellite 210 based on the determination that the RRC connection with the satellite 210 is complete. For example, the signals transmitted and/or received by the electronic device 101 and the satellite 210 may be described and/or promulgated with reference to an LTE communication method and/or communication standard. However, embodiments of the present disclosure are not limited in this regard. For example, the signals transmitted by the satellite 210 to the electronic device 101 and/or the signals transmitted by the electronic device 101 to the satellite 210 are not limited to the LTE communication method (and/or LTE communication standard) and may include signals defined in other communication methods.

According to an embodiment, the electronic device 101 (e.g., the processor 120 or 300) may, in operation 805, store the connection information of the satellite 210 in the memory 304 based on the connection with the satellite 210. For example, the connection information of the satellite 210 may include information related to at least one of the time point 400 (e.g., an initial reception time point) at which the electronic device 101 detects the satellite 210, the communication quality at the time point 400 at which the electronic device 101 detects the satellite 210, the time point 410 at which the electronic device 101 is connected to the satellite 210, or the communication quality at the time point 410 at which the electronic device 101 is connected to the satellite 210. For example, the time point 400 at which the electronic device 101 detects the satellite 210 may represent a time point at which the electronic device 101 first receives a signal exceeding a designated quality from the satellite 210. By way of example, information related to the detection of the satellite 210 may be matched to the orbit information of the satellite 210 and stored. For example, the time point 410 at which the connection to the satellite is established may include a time point at which it is determined that the RRC connection of the electronic device 101 to the satellite 210 is completed or a time point at which the RRC connection setup complete message is transmitted. By way of example, the connection information related to the satellite 210 may be matched to the orbit information of the satellite 210 and stored. For example, information related to at least one of the time point 400 (e.g., the initial reception time point) at which the electronic device 101 detects the satellite 210 or the communication quality at the time point 400 at which the satellite 210 is detected may be stored at the time point of detection of the satellite 210. For example, information related to at least one of the time point 410 at which the electronic device 101 is connected to the satellite 210 or the communication quality at the time point 410 at which the satellite 210 is connected may be stored at the time point at which it is determined that the electronic device 101 is connected to the satellite 210.

According to an embodiment, the electronic device 101 (e.g., the processor 120 or 300) may determine that the connection information of the satellite 210 is present in the electronic device 101 (e.g., “YES” in operation 801), proceed to operation 807, and identify (or acquire) the connection information of the satellite 210 from the memory 304. For example, the processor 300 may identify (or configure) a time point (e.g., the satellite signal transmission time point 610 in FIG. 6 or the satellite signal transmission time point 710 in FIG. 7) for transmitting a signal to the satellite 210 based on the connection information of the satellite 210. The processor 300 may control the communication circuit 302 to perform connection with the satellite 210 when the time point for transmitting a signal to the satellite 210 arrives. By way of example, the connecting with the satellite 210 may include a series of operations (e.g., a RACH procedure) for the electronic device 101 to transmit a RACH preamble to the satellite 210 and receive a RACH response from the satellite 210, and a series of operations for establishing RRC with the satellite 210.

According to an embodiment, the electronic device 101 (e.g., the processor 120 or 300) may, based on the satellite 210 being connected, perform satellite communication through the satellite 210. The electronic device 101 (e.g., the processor 120 or 300) may store (or update) satellite communication information related to the satellite 210 in the memory 304 during the satellite communication. For example, the satellite communication information may include information related to at least one of at least one of the time point 420 at which the electronic device 101 acquires (or receives) a signal having a maximum communication quality from the satellite 210, the maximum communication quality of the signal received from the satellite 210, the time point 430 at which the electronic device 101 is disconnected from the satellite 210, or the communication quality at the time point 430 at which the electronic device 101 is disconnected from the satellite 210.

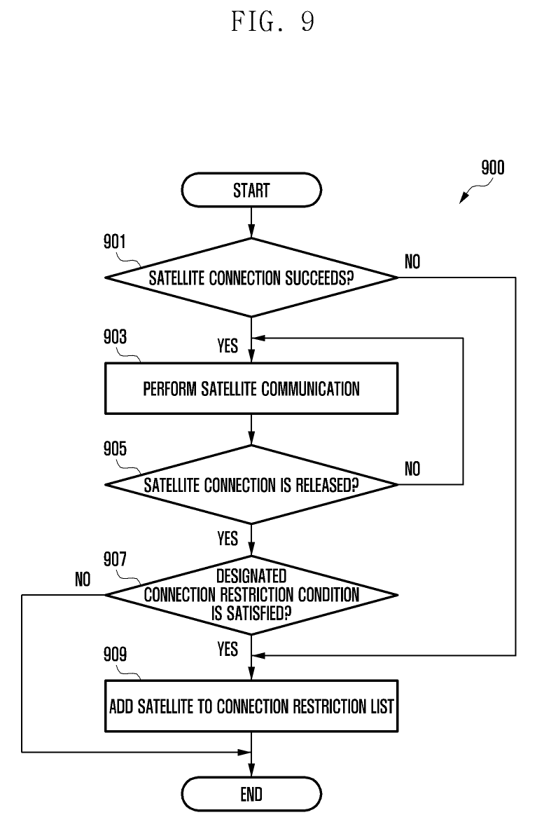

FIG. 9 is flowchart 900 for configuring a connection restriction list of a satellite by an electronic device, according to an embodiment. According to an embodiment, at least a portion of FIG. 9 may include a detailed operation of operation 805 in FIG. 8. In the flowchart 900, respective operations may be sequentially performed, but may not be necessarily performed sequentially. For example, the sequential position of each operation may be changed, or at least two operations may be performed in parallel. In an embodiment, the operations of flowchart 900 may be performed by the electronic device 101 as described above with reference to FIGS. 1, 2A, 2B, 3, 4, 5A, 5B, 6, 7 and 8.

As shown in FIG. 9, the electronic device 101 (e.g., the processor 120 in FIG. 1 or the processor 300 in FIG. 3) may, based on performing connection to the detected satellite 210 through search related to the satellite (e.g., operation 805 in FIG. 8), in operation 901, identify whether the connection to the satellite 210 succeeds. For example, the connection to the satellite 210 may include an RRC connection procedure and a RACH procedure with the satellite 210.

According to an embodiment, the electronic device 101 (e.g., the processor 120 or 300) may, based on the connection to the satellite 210 succeeding (e.g., “YES” in operation 901), in operation 903, perform satellite communication. For example, the satellite communication may include a series of operations in which the electronic device 101 may transmit and/or receive, through the satellite 210, a signal and/or data related to at least one of an emergency message sending service, an emergency call service, a messaging service (e.g., a small message service (SMS), a multimedia message service (MMS), or a rich communication service (RCS) message), a voice call, a video call, a data communication service (e.g., information about various applications that provide data communication, including Internet browser apps), or a location sharing service (e.g., longitude/latitude coordinates, map information related to the location of the non-terrestrial communication device 210, navigation, or street view). Alternatively, the flowchart 900 may, based on the connection to the satellite 210 not succeeding (e.g., “NO” in operation 901), proceed to operation 909.

According to an embodiment, the electronic device 101 (e.g., the processor 120 or 300) may, in operation 905, identify whether the connection with the satellite 210 is released. For example, the release of the connection with the satellite 210 may include a state in which no signal is received from the satellite 210 for a designated time period, or a state in which a signal having a designated quality or lower is received from the satellite 210 for a designated time period.

According to an embodiment, the electronic device 101 (e.g., the processor 120 or 300) may, based on the connection to the satellite 210 not being released (e.g., “NO” in operation 905), may return to operation 903, and may continue to perform satellite communication.

According to an embodiment, the electronic device 101 (e.g., the processor 120 or 300) may, based on the connection to the satellite 210 being released (e.g., “YES” in operation 905), in operation 907, identify whether the connection available time with the satellite 440 satisfies a designated connection restriction condition. For example, the processor 300 may, based on determining that the connection available time with the satellite 440 exceeds a designated minimum reference time, determine that the designated connection restriction condition is not satisfied. For example, the processor 300 may, based on the connection available time with the satellite 440 being less than or equal to the designated minimum reference time, determine that the designated connection restriction condition is satisfied. By way of example, the designated minimum reference time may include a minimum time acquired for the electronic device 101 and the satellite 210 to transmit and receive the satellite signal.

According to an embodiment, the electronic device 101 (e.g., the processor 120 or 300) may, based on determining that the connection available time with the satellite 440 does not satisfy the designated connection restriction condition (e.g., “NO” in operation 907), end an embodiment for configuring a connection restriction list of the satellite. For example, the processor 300 may, based on determining that the connection available time with the satellite 440 does not satisfy the designated connection restriction condition, determine that the electronic device 101 may perform satellite communication through the satellite 210. The processor 300 may, based on the satellite 210 being detected, control the communication circuit 302 to cause the electronic device 101 to attempt connection to the satellite 210.

According to an embodiment, the electronic device 101 (e.g., the processor 120 or 300) may, based on the connection to the satellite 210 failing (e.g., “NO” in operation 901) or based on determining that the connection available time with the satellite 440 satisfies the designated connection restriction condition (e.g., “YES” in operation 907), in operation 909, add the satellite with which the electronic device 101 attempted to connect to the connection restriction list. For example, the processor 300 may, based on detecting that the satellite 210 is included in the connection restriction list, restrict connection to the corresponding satellite 210. For example, the operation of restricting the connection to the satellite may include a series of operations of restricting transmission of a RACH preamble or RRC connection request message for the connection with the satellite. By way of example, the connection restriction list related to the satellite may include at least some of satellite information (e.g., orbit information of the satellite and/or identification information of the satellite) related to the satellite to which connection of the electronic device 101 is restricted.

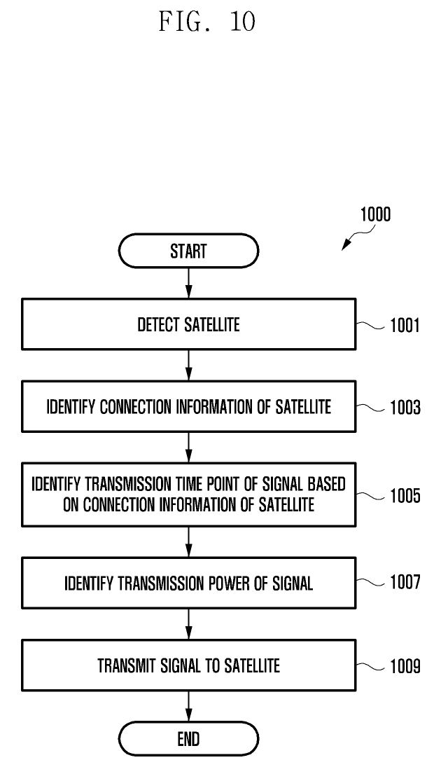

FIG. 10 is a flowchart 1000 for configuring transmission power of a signal to be transmitted from an electronic device 101 to a satellite, according to an embodiment. In flowchart 1000, respective operations may be sequentially performed, but may not be necessarily performed sequentially. For example, the sequential position of each operation may be changed, or at least two operations may be performed in parallel. In an embodiment, the operations of flowchart 1000 may be performed by the electronic device 101 as described above with reference to FIGS. 1, 2A, 2B, 3, 4, 5A, 5B, 6, 7, 8 and 9.

As shown in FIG. 10, an electronic device 101 (e.g., the processor 120 in FIG. 1 or the processor 300 in FIG. 3) may, in operation 1001, detect a satellite 210 to which the electronic device 101 may be connected (or registered) through a search (or scan) related to the satellite. For example, the detection of the satellite 210 to which the electronic device 101 may be connected (or registered) may include a state in which the electronic device 101 has received a satellite signal exceeding a designated quality from the satellite 210. For example, the designated quality may include a minimum communication quality that is determined to be such that the electronic device 101 is able to restore (or decode) the signal received by the electronic device 101 from the satellite 210.

According to an embodiment, the electronic device 101 (e.g., the processor 120 or 300) may, in operation 1003, identify connection information related to the satellite 210 detected through a search (or scan) related to the satellite. By way of example, the processor 300 may acquire the connection information related to the satellite 210 from the memory 304. For example, the processor 300 may, based on the connection information related to the satellite 210 not being present in the memory 304, control the communication circuit 302 to perform connection with the satellite 210. The processor 300 may store in the memory 304 connection information related to the satellite 210 that is acquired through the connection with the satellite 210. By way of example, the connection information related to the satellite 210 may include information acquired by the electronic device 101 through connection with the satellite 210 at the previous time point. By way of example the connection information related to the satellite 210 may include information acquired (or received) by the electronic device 101 through connection with a satellite (or another satellite) traveling (or orbiting) along an orbit substantially similar and/or the same as that of the satellite 210 at the previous time point.

According to an embodiment, the electronic device 101 (e.g., the processor 120 or 300) may, in operation 1005, identify (or configure) a time point (e.g., a signal transmission time point) for transmitting a signal to the satellite 210 based on the connection information related to the satellite 210. For example, the processor 300 may configure the time point for transmitting the satellite signal based on the communication quality at the time point 410 at which the electronic device 101 is connected to the satellite 210 at the previous time point. For example, the processor 300 may configure the time point for transmitting the satellite signal based on the time point 400 at which the electronic device 101 receives the signal from the satellite 210 at the previous time point and the time point 410 at which the electronic device 101 is connected to the satellite 210 at the previous time point. For example, the processor 300 may configure the time point for transmitting the satellite signal based on a communication quality at the time point 400 at which the electronic device 101 receives the signal from the satellite 210 at the previous time point and a communication quality at the time point 410 at which the electronic device 101 is connected to the satellite 210 at the previous time point. For example, the processor 300 may configure the time point for transmitting the satellite signal based on the maximum communication quality of the signal received by the electronic device 101 from the satellite 210 at the previous time point or the time point 420 at which the electronic device 101 receives the signal having the maximum communication quality from the satellite 210 at the previous time point.

According to an embodiment, the electronic device 101 (e.g., the processor 120 or 300) may, in operation 1007, identify (or determine) transmission power of the satellite signal to be transmitted to the satellite 210. For example, the processor 300 may identify that a designated power configuration condition is satisfied based on at least one of the maximum communication quality of the signal received from the satellite 210 at the previous time point and/or the connection available time with the satellite 440. For example, the processor 300 may, based on determining that the designated power configuration condition is not satisfied, configure relatively high power (e.g., the maximum transmission power) as the transmission power of the signal within a range that may be supported by the electronic device 101. By way of example, a state in which the designated power configuration condition is not satisfied may include a state in which the maximum communication quality acquired at the previous time point is equal to or less than the designated fifth reference quality, and/or a state in which the connection available time with the satellite 440 at the previous time point is equal to or less than the designated third reference time. For example, if it is determined that the designated power configuration condition is satisfied, the processor 300 may configure the transmission power of the signal based on the communication quality at the time point 410 at which the electronic device 101 is connected to the satellite 210 at the previous time point and the communication quality at the time point for the electronic device 101 to transmit the signal to the satellite 210 at the previous time point. For example, the transmission power of the signal may be configured based on a difference value between the maximum transmission power supportable by the electronic device 101 and the designated fourth reference quality. For example, the designated fourth reference quality may be configured based on a difference value between the communication quality at the time point 410 at which the electronic device 101 is connected to the satellite 210 at the previous time point and the communication quality at the time point for transmitting a signal to the satellite 210. By way of example, a state in which the designated power configuration condition is satisfied may include a state in which the maximum communication quality acquired at the previous time point exceeds the designated fifth reference quality and a state in which the connection available time with the satellite 440 at the previous time point exceeds the designated third reference time.

According to an embodiment, the electronic device 101 (e.g., the processor 120 or 300) may, in operation 1009, transmit a signal to the satellite 210 based on the transmission power for the signal and the time point for transmitting a signal to the satellite 210. For example, the processor 300 may control the communication circuit 302 to transmit a RACH preamble for connection with the satellite 210 based on the transmission power of the satellite signal when a time point for transmitting a signal to the satellite 210 configured based on the connection information related to the satellite 210 arrives.

According to an embodiment, the electronic device 101 (e.g., the processor 120 or 300) may, based on the power saving mode related to the satellite 210 being configured to be activated, identify (or determine) the transmission power of the satellite signal to be transmitted to the satellite 210. For example, the electronic device 101 (e.g., the processor 120 or 300) may, based on the power saving mode related to the satellite 210 not being configured to be activated, configure relatively high power (e.g., the maximum transmission power) as the transmission power of the signal within a range that may be supported by the electronic device 101.

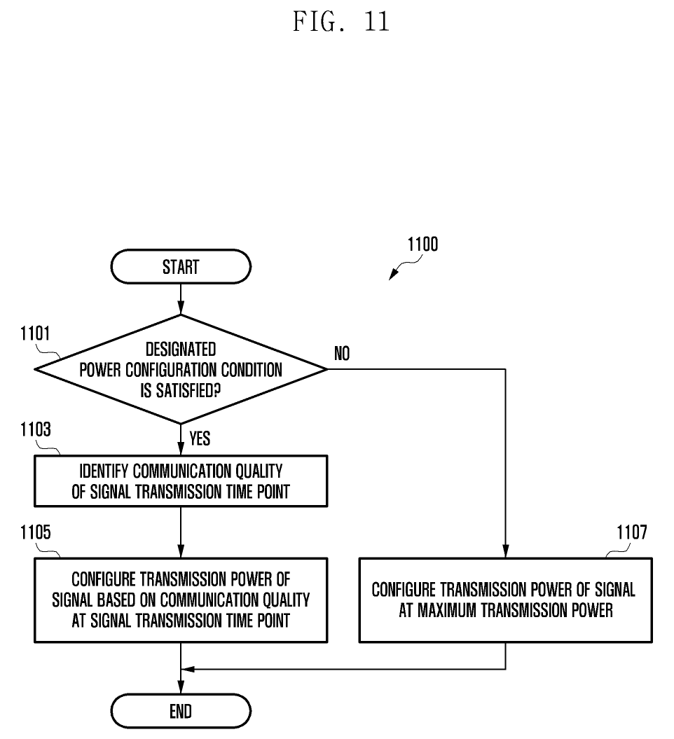

FIG. 11 is a flowchart 1100 for configuring transmission power of a signal to be transmitted from an electronic device 101 to a satellite based on a quality of communication with a satellite, according to an embodiment. According to an embodiment, at least a portion of FIG. 11 may include a detailed operation of operation 1007 in FIG. 10. In flowchart 1100, respective operations may be sequentially performed, but may not be necessarily performed sequentially. For example, the sequential position of each operation may be changed, or at least two operations may be performed in parallel. In an embodiment, the operations of flowchart 1100 may to be performed by the electronic device 101 as described above with reference to FIGS. 1, 2A, 2B, 3, 4, 5A, 5B and 6-10.

As shown in FIG. 11, the electronic device 101 (e.g., the processor 120 in FIG. 1 or the processor 300 in FIG. 3) may, in operation 1101, identify whether the connection information related to the satellite 210 satisfies a designated power configuration condition. For example, the processor 300 may, based on the maximum communication quality acquired at the previous time point being less than or equal to the designated fifth reference quality or the connection available time with the satellite 440 at the previous time point is less than or equal to the designated third reference time, determine that the designated power configuration condition is not satisfied. For example, the processor 300 may, based on the maximum communication quality acquired at the previous time point exceeding the designated fifth reference quality or the connection available time with the satellite 440 at the previous time point exceeds the designated third reference time, determine that the designated power configuration condition is satisfied. By way of example, the designated fifth reference quality may include a minimum communication quality configured to determine whether the transmission power of the satellite signal is configured based on the connection information related to the satellite 210. By way of example, the designated third reference time may include a designated minimum reference time configured to determine whether the transmission power of the satellite signal is configured based on the connection information related to the satellite 210.

According to an embodiment, the electronic device 101 (e.g., the processor 120 or 300) may, based on determining that the connection information related to the satellite 210 satisfies the designated power configuration condition (e.g., “YES” in operation 1101), in operation 1103, identify the communication quality at the time point configured for transmitting a signal to the satellite 210.

According to an embodiment, the electronic device 101 (e.g., the processor 120 or 300) may, in operation 1105, configure transmission power of the signal transmitted to the satellite 210 based on the communication quality at the time point configured to transmit the signal to the satellite 210. For example, the processor 300 may configured transmission power of the signal transmitted to the satellite 210 based on a difference value (e.g., about 31 dBm) between relatively high power (e.g., the maximum transmission power) (e.g., about 36 dBm) within a range supportable by the electronic device 101 and the designated fourth reference quality (e.g., about 5 dBm). For example, the designated fourth reference quality may be configured based on a difference value (e.g., about 5 dBm) between the communication quality (e.g., about -110 dBm) at the time point 410 at which the electronic device 101 is connected to the satellite 210 at the previous time point and the communication quality (e.g., about -105 dBm) at the time point for the electronic device 101 to transmit a signal to the satellite 210.

According to an embodiment, the electronic device 101 (e.g., the processor 120 or 300) may, based on determining that the connection information related to the satellite 210 does not satisfy the designated power configuration condition (e.g., “NO” in operation 1101), in operation 1107, configure relatively high power (e.g., the maximum transmission power) within the range supportable by the electronic device 101 as the transmission power of the signal.

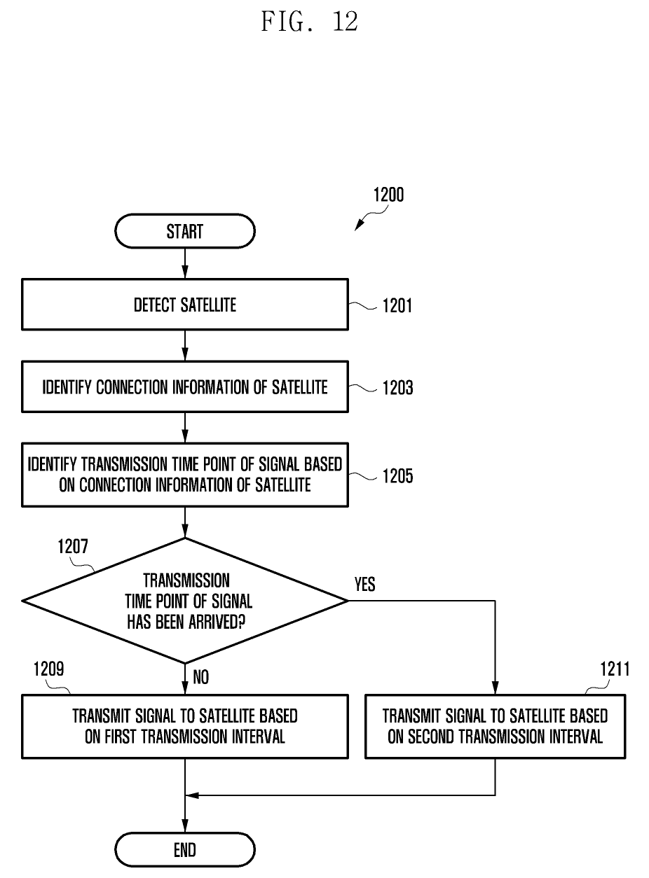

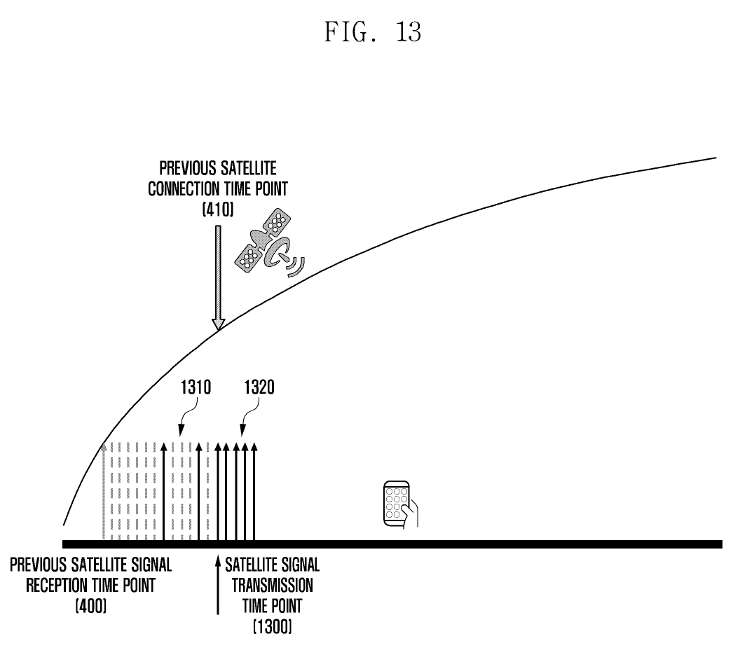

FIG. 12 is a flowchart 1200 for configuring a transmission interval of a signal to be transmitted from an electronic device to a satellite, according to an embodiment. In flowchart 1200, respective operations may be sequentially performed, but may not be necessarily performed sequentially. For example, the sequential position of each operation may be changed, or at least two operations may be performed in parallel. For example, the electronic device 101 in FIG. 12 may correspond to the electronic device 101 in FIGS. 1, 2, 3 or 4. For example, at least a portion of FIG. 12 may be described with reference to FIG. 13. FIG. 13 is an example of a transmission interval of a signal to be transmitted from an electronic device 101 to a satellite, according to an embodiment.

Referring to FIGS. 12 and 13, an electronic device 101 (e.g., the processor 120 in FIG. 1 or the processor 300 in FIG. 3) may, in operation 1201, detect (or search) a satellite 210 to which the electronic device 101 may be connected (or registered) through a search (or scan) related to the satellite. For example, the detection of the satellite 210 to which the electronic device 101 may be connected (or registered) may include a state in which the electronic device 101 has received a satellite signal exceeding a designated quality from the satellite 210. For example, the designated quality may include a minimum communication quality that is determined to be such that the electronic device 101 is able to restore (or decode) the signal received by the electronic device 101 from the satellite 210.

According to an embodiment, the electronic device 101 (e.g., the processor 120 or 300) may, in operation 1203, identify connection information related to the satellite 210 detected through a search (or scan) related to the satellite. By way of example, the processor 300 may acquire the connection information related to the satellite 210 from the memory 304. By way of example, the connection information related to the satellite 210 may include information acquired by the electronic device 101 through connection with the satellite 210 at the previous time point. By way of example the connection information related to the satellite 210 may include information acquired (or received) by the electronic device 101 through connection with a satellite (or another satellite) traveling (or orbiting) along an orbit substantially similar and/or the same as that of the satellite 210 at the previous time point.

For example, the processor 300 may, based on the connection information related to the satellite 210 not being present in the memory 304, control the communication circuit 302 to perform connection with the satellite 210. The processor 300 may store in the memory 304 connection information related to the satellite 210 that is acquired through the connection with the satellite 210.

According to an embodiment, the electronic device 101 (e.g., the processor 120 or 300) may, in operation 1205, identify (or configure) a time point (e.g., a signal transmission time point) for transmitting a signal to the satellite 210 based on the connection information related to the satellite 210. For example, the processor 300 may configure the time point 1300 for transmitting the satellite signal based on the communication quality at the time point 410 at which the electronic device 101 is connected to the satellite 210 at the previous time point. For example, the processor 300 may configure the time point 1300 for transmitting the satellite signal based on the time point 400 at which the electronic device 101 receives the signal from the satellite 210 at the previous time point and the time point 410 at which the electronic device 101 is connected to the satellite 210 at the previous time point. For example, the processor 300 may configure the time point 1300 for transmitting the satellite signal based on a communication quality at the time point 400 at which the electronic device 101 receives the signal from the satellite 210 at the previous time point and a communication quality at the time point 410 at which the electronic device 101 is connected to the satellite 210 at the previous time point. For example, the processor 300 may configure the time point 1300 for transmitting the satellite signal based on the maximum communication quality of the signal received by the electronic device 101 from the satellite 210 at the previous time point or the time point 420 at which the electronic device 101 receives the signal having the maximum communication quality from the satellite 210 at the previous time point.

According to an embodiment, the electronic device 101 (e.g., the processor 120 or 300) may, in operation 1207, identify whether a time point (e.g., a signal transmission time point) for transmitting a signal to the satellite 210 has arrived.

According to an embodiment, the electronic device 101 (e.g., the processor 120 or 300) may, based on the time point (e.g., the signal transmission time point) for transmitting a signal to the satellite 210 not having arrived (e.g., “NO” in operation 1207), in operation 1209, transmit the signal to the satellite 210 at a designated first interval. For example, the processor 300 may control the communication circuit 302 to transmit the signal (e.g., the RACH preamble) to the satellite 210 based on the designated first interval 1310 because it is predicted that the signal has a relatively low probability of reaching the satellite 210 before the time point 1300 for transmitting a signal to the satellite 210 arrives. The processor 300 may, based on a response signal (e.g., the RACH response signal) corresponding to the signal to the satellite 210 not having been received, control the communication circuit 302 to transmit the signal (e.g., the RACH preamble) to the satellite 210 based on the designated first interval 1310 before the time point 1300 for transmitting a signal to the satellite 210 arrives. For example, the designated first interval may be configured (or varied) such that a relatively lower quality signal received from the satellite 210 results in a relatively wider transmission interval for the signal.

According to an embodiment, the electronic device 101 (e.g., the processor 120 or 300) may, based on the time point (e.g., the signal transmission time point) for transmitting a signal to the satellite 210 having arrived (e.g., “YES” in operation 1207), in operation 1211, transmit the signal to the satellite 210 at a designated second interval. For example, the processor 300 may control the communication circuit 302 to transmit the signal (e.g., the RACH preamble) to the satellite 210 based on the designated second interval 1320 configured to be shorter than the designated first interval 1310 because it is predicted that the signal has a relatively high probability of reaching the satellite 210 based on the time point 1300 for transmitting a signal to the satellite 210 having arrived. The processor 300 may, based on a response signal (e.g., the RACH response signal) corresponding to the signal to the satellite 210 not having been received, control the communication circuit 302 to transmit the signal (e.g., the RACH preamble) to the satellite 210 based on the designated second interval 1320 after the time point 1300 for transmitting a signal to the satellite 210 arrives.

According to an embodiment, the electronic device 101 may, based on the response signal (e.g., the RACH response signal) for the signal transmitted to the satellite 210 based on the designated first interval before the time point 1300 for transmitting a signal to the satellite 210 arrives having been received, perform a procedure for connection with the satellite 210.

According to an embodiment, the electronic device 101 may restrict transmission of the signal to the satellite 210 because it is predicted that the signal has a relatively low probability of reaching the satellite 210 before the time point 1300 for transmitting a signal to the satellite 210 arrives.

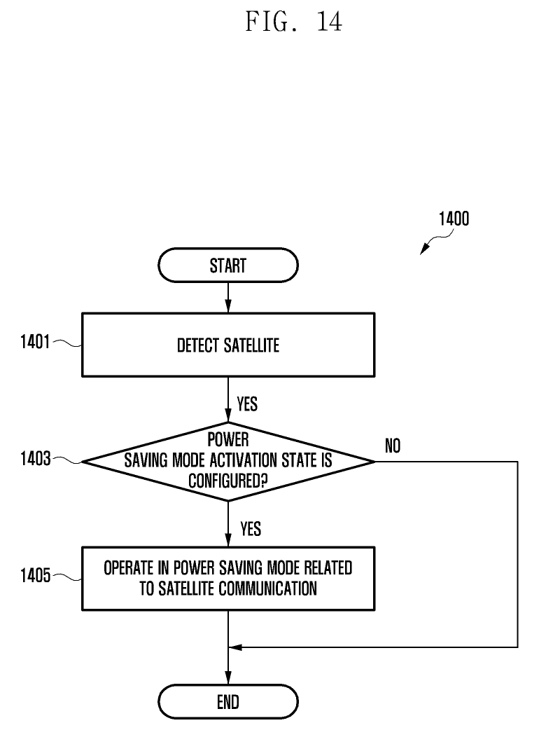

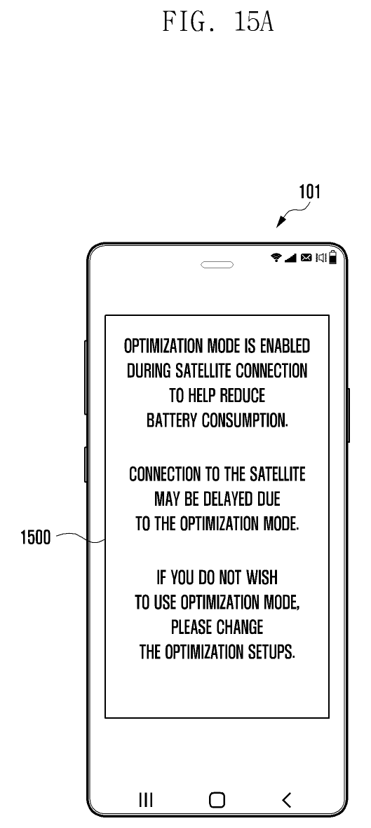

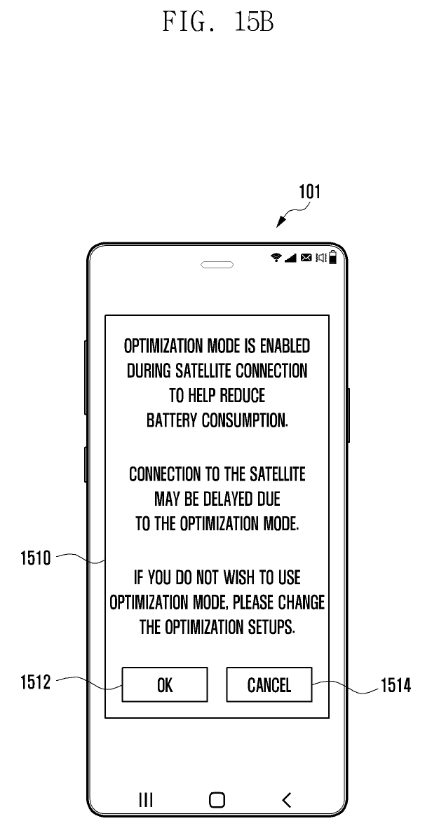

FIG. 14 is a flowchart 1400 for selectively configuring a transmission time point of a signal in an electronic device, according to an embodiment. In the flowchart 1400, respective operations may be sequentially performed, but may not be necessarily performed sequentially. For example, the sequential position of each operation may be changed, or at least two operations may be performed in parallel. In an embodiment, the operations of flowchart 1400 may be performed by the electronic device 101 as described above with reference to FIGS. 1, 2A, 2B, 3, 4, 5A, 5B and 6-13. For example, at least a portion of FIG. 14 may be described with reference to FIGS. 15A and 15B. FIGS. 15A and 15B are examples of switching information to a power saving mode output from an electronic device, according to an embodiment.

As shown in FIG. 14, an electronic device 101 (e.g., the processor 120 in FIG. 1 or the processor 300 in FIG. 3) may, in operation 1401, detect a satellite 210 to which the electronic device 101 may be connected (or registered) through a search (or scan) related to the satellite. For example, the detection of the satellite 210 to which the electronic device 101 may be connected (or registered) may include a state in which the electronic device 101 has received a satellite signal exceeding a designated quality from the satellite 210. For example, the designated quality may include a minimum communication quality that is determined to be such that the electronic device 101 is able to restore (or decode) the signal received by the electronic device 101 from the satellite 210.

According to an embodiment, the electronic device 101 (e.g., the processor 120 or 300) may, in operation 1403, identify whether the power saving mode related to the satellite is configured to be activated. For example, the processor 300 may, based on a battery saving menu or a current saving menu related to emergency communication being configured to be activated, determine that the power saving mode related to the satellite communication is configured to be activated. For example, the power saving mode related to the satellite communication may be configured to be activated or deactivated based on a user input as a sub-menu of the battery saving menu or the current saving menu related to emergency communication. By way of example, the power saving mode related to the satellite communication may include an operation of configuring a transmission time point and/or transmission power of a signal related to the satellite communication based on the connection information related to the satellite 210 to reduce battery consumption of the electronic device 101 by the satellite communication.

According to an embodiment, the electronic device 101 (e.g., processor 120 or 300) may, based on the power saving mode related to the satellite communication not being configured to be activated (e.g., “NO” in operation 1403), end an embodiment for configuring the transmission time point and/or transmission power of the signal based on the connection information related to the satellite 210. For example, the processor 300 may, based on the power saving mode related to the satellite communication being configured to be deactivated, determine not to configure the transmission time point and/or transmission power of the signal based on the connection information related to the satellite 210. The processor 300 may control the communication circuit 302 to transmit a signal (e.g., the RACH preamble) to the satellite 210 by considering only the time point 400 at which the signal is received from the satellite 210.

According to an embodiment, the electronic device 101 (e.g., the processor 120 or 300) may, based on the power saving mode related to the satellite communication being configured to be activated (e.g., “YES” in operation 1403), in operation 1405, operate in the power saving mode related to the satellite. For example, the processor 300 may, based on the power saving mode related to the satellite communication being configured to be activated, control an output device (e.g., the display module 160 in FIG. 1 or 2A) of the electronic device 101 to output guidance information 1500 or 1510 related to the switching to the power saving mode related to the satellite communication. By way of example, the guidance information 1500 or 1510 related to the switching to the power saving mode may be output in the form of pop-up window. For example, the guidance information 1500 or 1510 related to the switching to the power saving mode may include, as shown in FIGS. 15A or 15B, information indicating switching to a power saving mode (or optimization mode) to reduce battery consumption by the satellite communication, and information about delays in connecting with the satellite based on an operation of the power saving mode. For example, the guidance information 1510 related to the switching to the power saving mode may include, as shown in FIG. 15B, a first button 1512 (e.g., an OK button) for configuring an activation state of the power saving mode (or optimization mode) and/or a second button 1514 (e.g., a Cancel button) for configuring a deactivation state of the power saving mode.

For example, the processor 300 may, based on an input (e.g., a user input) related to the first button 1512 (e.g., the OK button) for configuring the activation state of the power saving mode (or optimization mode) included in the guidance information 1510 related to the switching to the power saving mode having been acquired, operate in the power saving mode related to the satellite communication.

For example, the processor 300 may, based on an input (e.g., a user input) related to the second button 1514 (e.g., the Cancel button) for configuring the deactivation state of the power saving mode (or optimization mode) being included in the guidance information 1510 related to the switching to the power saving mode, restrict an operation in the power saving mode related to the satellite communication. The processor 300 may control the communication circuit 302 to transmit a signal (e.g., the RACH preamble) to the satellite 210 by considering only the time point 400 at which the signal is received from the satellite 210.

For example, the processor 300 may, based on an input (e.g., a user input) related to the first button 1512 (e.g., the OK button) or the second button 1514 has not been acquired for a designated time period from a time point at which the guidance information 1510 related to the switching to the power saving mode has been output, operate in the power saving mode related to the satellite communication.

For example, the processor 300 may, when operating in the power saving mode related to the satellite communication, configure the transmission time point and/or transmission power of the signal based on the connection information related to the satellite 210 (e.g., operation 505 in FIG. 5A, operation 1005 in FIG. 10, operation 1007 in FIG. 10, operation 1105 in FIG. 11, or operation 1205 in FIG. 12). The processor 300 may, based on the time point for transmitting a signal having arrived, control the communication circuit 302 to transmit the signal (e.g., the RACH preamble) to the satellite 210.

According to an embodiment, the electronic device 101 may, based on the power saving mode related to the satellite 210 being configured as the default operation of the electronic device 101, emit the operation (e.g., operation 1403 in FIG. 14) of identifying whether the power saving mode of the electronic device 101 is configured to be activated.

According to an embodiment, the electronic device 101 may, based on being on an operation state of the electronic device 101 that satisfies a power saving mode switching condition and/or the power saving mode being configured to be activated, operate in the power saving mode related to the satellite communication. For example, the processor 300 may determine whether the power saving mode switching condition is satisfied based on at least one of a battery level of the electronic device 101, a communication quality with the satellite 210, or a connection available time with the satellite 440 acquired at the previous time point. For example, a state satisfying the power saving mode switching condition may include at least one of a state in which the battery level of the electronic device 101 is less than or equal to a designated reference level, a state in which the communication quality with the satellite 210 exceeds the designated sixth reference quality, or a state in which the connection available time with the satellite 440 acquired at the previous time point exceeds the designated fourth reference time. For example, a state not satisfying the power saving mode switching condition may include at least one of a state in which the battery level of the electronic device 101 exceeds a designated reference level, a state in which the communication quality with the satellite 210 is less than or equal to the designated sixth reference quality, or a state in which the connection available time with the satellite 440 acquired at the previous time point is less than or equal to the designated fourth reference time. By way of example, the designated sixth reference quality may represent a communication quality configured to determine whether to switch to the power saving mode based on the communication quality with the satellite 210. For example, the designated fourth reference time may represent a reference time configured to determine whether to switch to the power saving mode based on the connection available time 400 of the electronic device 101 to the satellite 210 at the previous time point.

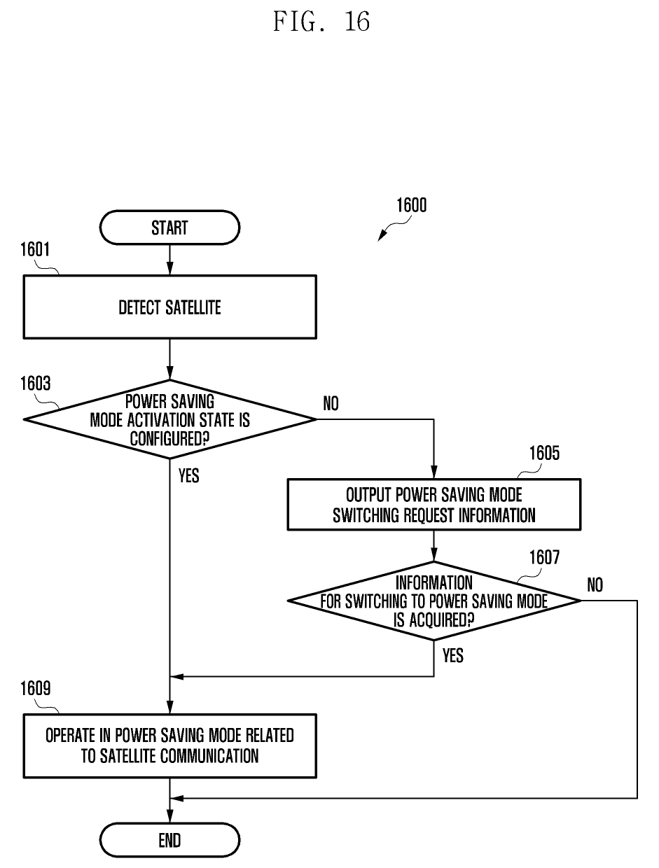

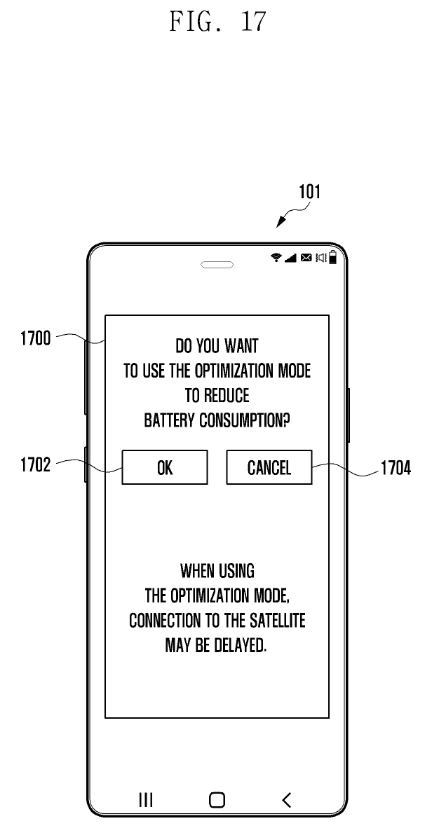

FIG. 16 is flowchart 1600 for operation of a power saving mode related to satellite communication in an electronic device, according to an embodiment. In the flowchart 1600, respective operations may be sequentially performed, but may not be necessarily performed sequentially. For example, the sequential position of each operation may be changed, or at least two operations may be performed in parallel. In an embodiment, the operations of flowchart 1600 may be performed by the electronic device 101 as described above with reference to FIGS. 1, 2A, 2B, 3, 4, 5A, 5B, 6–14, 15A and 15B. For example, at least a portion of FIG. 16 may be described with reference to FIG. 17. FIG. 17 is an example of switching information to a power saving mode output from an electronic device, according to an embodiment.

As shown in FIG. 16, an electronic device 101 (e.g., the processor 120 in FIG. 1 or the processor 300 in FIG. 3) may, in operation 1601, detect a satellite 210 to which the electronic device 101 may be connected (or registered) through a search (or scan) related to the satellite. For example, the detection of the satellite 210 to which the electronic device 101 may be connected (or registered) may include a state in which the electronic device 101 has received a satellite signal exceeding a designated quality from the satellite 210. For example, the designated quality may include a minimum communication quality that is determined to be such that the electronic device 101 is able to restore (or decode) the signal received by the electronic device 101 from the satellite 210.

According to an embodiment, the electronic device 101 (e.g., the processor 120 or 300) may, in operation 1603, identify whether the power saving mode related to the satellite is configured to be activated. For example, the processor 300 may, based on a battery saving menu or a current saving menu related to emergency communication being configured to be activated, determine that the power saving mode related to the satellite communication is configured to be activated. For example, the power saving mode related to the satellite communication may be configured to be activated or deactivated based on a user input as a sub-menu of the battery saving menu or the current saving menu related to emergency communication. By way of example, the power saving mode related to the satellite communication may include an operation of configuring a transmission time point and/or transmission power of a signal related to the satellite communication based on the connection information related to the satellite 210 to reduce battery consumption of the electronic device 101 by the satellite communication.

According to an embodiment, the electronic device 101 (e.g., the processor 120 or 300) may, based on the power saving mode related to the satellite communication not being configured to be activated (e.g., “NO” in operation 1603), in operation 1605, output power saving mode switching request information. For example, the processor 300 may, based on the power saving mode related to the satellite communication being configured to be deactivated, control the output device (e.g., the display module 160 in FIGS. 1 or 2A) of the electronic device 101 to output guidance information 1700 inquiring about whether to use the power saving mode (or optimization mode). By way of example, the guidance information 1700 inquiring about whether to use the power saving mode (or optimization mode) may be output in the form of pop-up window. By way of example, the guidance information 1700 inquiring about whether to use the power saving mode (or optimization mode) may include delay information at the time point of connection with the satellite based on an operation of the power saving mode. For example, the guidance information 1700 inquiring about whether to use the power saving mode (or optimization mode) may include a first button 1702 (e.g., an OK button) for configuring an activation state of the power saving mode (or optimization mode) and/or a second button 1704 (e.g., a Cancel button) for configuring a deactivation state of the power saving mode.

According to an embodiment, the electronic device 101 (e.g., the processor 120 or 300) may, in operation 1607, identify whether information for switching to the power saving mode has been acquired. For example, the processor 300 may, based on an input (e.g., a user input) related to the first button 1702 (e.g., the OK button) for configuring the activation state of the power saving mode (or optimization mode) included in the guidance information 1700 inquiring about whether to use the power saving mode (or optimization mode) having been acquired, determine that the information for switching to the power saving mode has been acquired.

For example, the processor 300 may, based on an input (e.g., a user input) related to the second button 1704 (e.g., the Cancel button) for configuring the deactivation state of the power saving mode (or optimization mode) included in the guidance information 1700 inquiring about whether to use the power saving mode (or optimization mode) having been acquired, determine that the information for switching to the power saving mode has not been acquired. For example, the processor 300 may, based on an input (e.g., a user input) related to the first button 1702 (e.g., the OK button) or the second button 1704 has not been acquired for a designated time period from a time point at which the guidance information 1700 inquiring about whether to use the power saving mode (or optimization mode) having been output, determine that the information for switching to the power saving mode has not been acquired.

According to an embodiment, the electronic device 101 (e.g., the processor 120 or 300) may, based on the information for switching to the power saving mode not having been acquired (e.g., “NO” in operation 1607), end an embodiment for an operation in the power saving mode related to the satellite communication. For example, the processor 300 may, based on the information for switching to the power saving mode not having been acquired, determine not to configure the transmission time point and/or transmission power of the signal based on the connection information related to the satellite 210. The processor 300 may control the communication circuit 302 to transmit a signal (e.g., the RACH preamble) to the satellite 210 by considering only the time point 400 at which the signal is received from the satellite 210.

According to an embodiment, the electronic device 101 (e.g., the processor 120 or 300) may, based on the power saving mode related to the satellite communication being configured to be activated (e.g., “YES” in operation 1603) or the information for switching to the power saving mode having been acquired (e.g., “YES” in operation 1607), in operation 1609, operate in the power saving mode related to the satellite. For example, the processor 300 may, based on the power saving mode related to the satellite communication being configured to be activated, control the output device (e.g., the display) of the electronic device 101 to output guidance information 1500 related to the switching to the power saving mode related to the satellite communication.

For example, the processor 300 may, when operating in the power saving mode related to the satellite communication, configure the transmission time point and/or transmission power of the signal based on the connection information related to the satellite 210 (e.g., operation 505 in FIG. 5A, operation 1005 in FIG. 10, operation 1007 in FIG. 10, operation 1105 in FIG. 11, or operation 1205 in FIG. 12). The processor 300 may, based on the time point for transmitting a signal having arrived, control the communication circuit 302 to transmit the signal (e.g., the RACH preamble) to the satellite 210.

According to an embodiment, the electronic device 101 may, based on an operation state of the electronic device 101 that satisfies the power saving mode switching condition and/or the power saving mode being configured to be activated, operate in the power saving mode related to the satellite communication. For example, the processor 300 may determine whether the power saving mode switching condition is satisfied based on at least one of a battery level of the electronic device 101, a communication quality with the satellite 210, or a connection available time with the satellite 440 acquired at the previous time point.

According to an embodiment, an operation method of an electronic device (e.g., the electronic device 101 in FIGS. 1, 2A, 2B, 3, 4, 5A, 5B, 6–14, 15A, 15B, 16 and 17) may include an operation of, based on a satellite (e.g., the satellite 210 in FIG. 2) being detected, identifying whether the electronic device identifies whether connection information related to the satellite is present in the electronic device. According to an embodiment, the operation method of the electronic device may include an operation of, based on connection information related to the satellite existing in the electronic device, identify a time point for transmitting a signal to the satellite, based on the connection information. According to an embodiment, the operation method of the electronic device may include an operation of transmitting a signal to the satellite based on the time point for transmitting a signal to the satellite.

According to an embodiment, the operation of identifying the time point for transmitting a signal to the satellite may include an operation of configuring a time point for transmitting a signal to the satellite based on a communication quality at a time point at which the electronic device is connected to the satellite at a previous time point.

According to an embodiment, the operation of identifying the time point for transmitting a signal to the satellite may include an operation of configuring a time point for transmitting a signal to a satellite based on a difference value between a time point at which the electronic device receives the signal from the satellite at the previous time point and a time point at which the electronic device is connected to the satellite.

According to an embodiment, the operation of identifying the time point for transmitting a signal to the satellite may include an operation of configuring a time point for transmitting a signal to a satellite based on a difference value between a communication quality at the time point at which the electronic device receives the signal from the satellite at the previous time point and a communication quality at the time point at which the electronic device is connected to the satellite.

According to an embodiment, the operation of identifying the time point for transmitting a signal to the satellite may include an operation of configuring a time point for transmitting a signal to the satellite based on a maximum communication quality of a signal received by the electronic device from the satellite at the previous time point.

According to an embodiment, the operation of identifying the time point for transmitting a signal to the satellite may include an operation of configuring a time point for transmitting a signal to the satellite based on a time point at which the electronic device receives the signal having the maximum communication quality from the satellite at the previous time point.

According to an embodiment, the operation method of the electronic device may include an operation of configuring transmission power of the signal to be transmitted to the satellite based on the connection information related to the satellite and the communication quality at the time point for transmitting a signal to the satellite.

According to an embodiment, the operation of transmitting the signal may include an operation of transmitting the signal to the satellite based on the identified time point for transmitting a signal to the satellite and the configured transmission power.

According to an embodiment, the operation method of the electronic device may include an operation of, based on connection information related to the satellite not being present in the electronic device, performing connection to the satellite. According to an embodiment, the operation method of the electronic device may include an operation of storing the connection information acquired through the connection with the satellite in a memory of the electronic device.

The embodiments disclosed in the specification and the drawings are merely presented as specific examples to easily explain the technical features according to the embodiments of the disclosure and help understanding of the embodiments of the disclosure and are not intended to limit the scope of the embodiments of the disclosure. Therefore, the scope of an embodiment disclosed herein should be construed as encompassing all changes or modifications derived from the technical ideas of the embodiment disclosed herein in addition to the embodiment disclosed herein.

What is claimed is:

1. An electronic device, comprising:
one or more processors comprising processing circuitry; and
memory storing instructions,
wherein the instructions, when executed by the one or more processors individually or collectively, cause the electronic device to:
based on a satellite being detected, identify whether connection information related to the satellite is present in the memory;
based on the connection information related to the satellite being present in the memory, determine, based on the connection information, a transmission time point for transmitting a transmission signal to the satellite; and
transmit, during the transmission time point, the transmission signal to the satellite.

2. The electronic device of claim 1, wherein the connection information comprises at least one of:
a first previous time point at which the electronic device received a satellite signal from the satellite,
a first communication quality at the first previous time point,
a second previous time point at which the electronic device is coupled with the satellite,
a second communication quality at the second previous time point,
a maximum communication quality of a received signal received by the electronic device from the satellite,
a third previous time point at which the received signal is received from the satellite,
a fourth time point at which a connection of the electronic device to the satellite is released, or
a fourth communication quality at the fourth time point.

3. The electronic device of claim 2, wherein the instructions, when executed by the one or more processors individually or collectively, further cause the electronic device to:
determine the transmission time point based on the second communication quality.

4. The electronic device of claim 2, wherein the instructions, when executed by the one or more processors individually or collectively, further cause the electronic device to:
determine the transmission time point based on a difference between the first previous time point and the second previous time point.

5. The electronic device of claim 2, wherein the instructions, when executed by the one or more processors individually or collectively, further cause the electronic device to:
determine the transmission time point based on a difference between the first communication quality and the second communication quality.

6. The electronic device of claim 2, wherein the instructions, when executed by the one or more processors individually or collectively, further cause the electronic device to:
determine the transmission time point based on the maximum communication quality.

7. The electronic device of claim 2, wherein the instructions, when executed by the one or more processors individually or collectively, further cause the electronic device to:
determine the transmission time point based on the third previous time point.

8. The electronic device of claim 1, wherein the instructions, when executed by the one or more processors individually or collectively, further cause the electronic device to:
determine a transmission power of the transmission signal based on the connection information and a communication quality at the transmission time point; and
transmit, to the satellite during the transmission time point, the transmission signal based on the transmission power.

9. An operation method of an electronic device, the operation method comprising:
based on a satellite being detected, identifying whether connection information related to the satellite is present in a memory of the electronic device;
based on the connection information related to the satellite being present in the electronic device, determining a transmission time point for transmitting a transmission signal to the satellite, based on the connection information; and
transmitting, during the transmission time point, the transmission signal to the satellite.

10. The operation method of claim 9, wherein the connection information comprises at least one of:
a first previous time point at which the electronic device received a satellite signal from the satellite,
a first communication quality at the first previous time point,
a second previous time point at which the electronic device is coupled with the satellite,
a second communication quality at the second previous time point,
a maximum communication quality of a received signal received by the electronic device from the satellite,
a third previous time point at which the received signal is received from the satellite,
a fourth time point at which a connection of the electronic device to the satellite is released, or
a fourth communication quality at the fourth time point.

11. The operation method of claim 10, wherein the determining of the transmission time point comprises:
determining the transmission time point based on the second communication quality.

12. The operation method of claim 10, wherein the determining of the transmission time point comprises:
determining the transmission time point based on a difference between the first previous time point and the second previous time point.

13. The operation method of claim 10, wherein the determining of the transmission time point comprises:
determining the transmission time point based on a difference between the first communication quality and the second communication quality.

14. The operation method of claim 10, wherein the determining of the transmission time point comprises:
determining the transmission time point based on the maximum communication quality.

15. The operation method of claim 10, wherein the determining of the transmission time point comprises:
determining the transmission time point based on the third previous time point.

16. The operation method of claim 10, wherein the transmitting of the transmission signal comprises:
determining a transmission power of the transmission signal based on the connection information and a communication quality at the transmission time point; and
transmitting, to the satellite during the transmission time point, the transmission signal based on the transmission power.
